(19) United States
(12) Patent Application Publication
(10) Pub. No.: US 2025/0244687 A1
(43) Pub. Date: Jul. 31, 2025

(54) ELECTROPHOTOGRAPHIC APPARATUS

(71) Applicant: CANON KABUSHIKI KAISHA, Tokyo (JP)

(72) Inventors: FUMIYUKI HIYAMA, Shizuoka (JP); TAICHI SATO, Shizuoka (JP); AKIRA SAKAKIBARA, Shizuoka (JP); TSUTOMU NISHIDA, Shizuoka (JP)

(21) Appl. No.: 19/024,738

(22) Filed: Jan. 16, 2025

(30) Foreign Application Priority Data
Jan. 26, 2024 (JP) 2024-010285
Dec. 18, 2024 (JP) 2024-222370

(51) Int. Cl. G03G 5/043; G03G 5/06; G03G 5/07

(52) U.S. Cl. CPC G03G 5/0433; G03G 5/0605; G03G 5/0607; G03G 5/0631; G03G 5/075; G03G 2215/00957; G03G 2215/00962

(57) ABSTRACT

Provided is an electrophotographic apparatus including: an electrophotographic photosensitive member; a charging unit; an exposing unit; and a developing unit, wherein the electrophotographic photosensitive member includes a monolayer type photosensitive layer containing a charge generating material, a hole transporting material, an electron transporting material, and a first binder resin, wherein the photosensitive layer contains, as the first binder resin, a polyester resin having specific structural units, wherein the developing unit is a developing roller including a shaft body, an elastic layer arranged on an outer periphery of the shaft body, and a coating layer arranged on an outer periphery of the elastic layer, and wherein the coating layer contains a second binder resin and a silica particle.

### BACKGROUND OF THE INVENTION

### Field of the Invention

The present invention relates to an electrophotographic apparatus.

### Description of the Related Art

In recent years, there has been a demand for an electrophotographic image forming apparatus (hereinafter sometimes referred to as “electrophotographic apparatus”) having a longer service life and being capable of forming an image of higher image quality, and it has been desired to provide an apparatus having high image quality stability of an image to be output after repeated use (hereinafter sometimes referred to as “after endurance”).

An organic electrophotographic photosensitive member (hereinafter sometimes simply referred to as “electrophotographic photosensitive member” or “photosensitive member”) containing an organic photoconductive material (charge generating material) is used as an electrophotographic photosensitive member to be mounted on an electrophotographic apparatus or a process cartridge. In a recent electrophotographic apparatus, in addition to the above-mentioned measures for extending the service life, there has been a demand that high image quality be maintained from an initial stage to a stage after endurance by suppressing a decrease in transfer efficiency after endurance to improve image quality.

A developing roller to be used in the electrophotographic apparatus is brought into pressure contact with or brought close to a latent image bearing member with a predetermined contact width to carry a thin layer of toner formed with a coating blade. Accordingly, there has been a demand that the developing roller be flexible and easily deformed, and be excellent in set resistance, and have a charge imparting property to a developer, and the roller be suppressed in adhesion of the developer or the like.

In each of Japanese Patent Application Laid-Open No. 2015-114392 and Japanese Patent Application Laid-Open No. 2019-168614, there is a description of a developing roller including: a mandrel; an elastic layer formed of a rubber material having imparted thereto electroconductivity on an outer periphery of the mandrel; and a layer formed of a resin material on an outer periphery thereof.

According to investigations by the inventors of the present invention, when an electrophotographic apparatus including the developing roller described in each of Japanese Patent Application Laid-Open No. 2015-114392 and Japanese Patent Application Laid-Open No. 2019-168614 is used for the purpose of suppressing a decrease in filming, a failure related to transfer after endurance may occur. Specifically, toner scattering and a decrease in transfer efficiency may occur, and hence there has been room for improvement.

### SUMMARY OF THE INVENTION

Thus, an object of the present invention is to provide an excellent electrophotographic apparatus in which a decrease in transfer efficiency and toner scattering after endurance can be suppressed, and high image quality is maintained from an initial stage to a stage after endurance in an electrophotographic apparatus using a developing roller for suppressing filming.

An electrophotographic apparatus according to one aspect of the present invention is an electrophotographic apparatus including: an electrophotographic photosensitive member; a charging unit configured to charge a surface of the electrophotographic photosensitive member; an exposing unit configured to irradiate the charged surface of the electrophotographic photosensitive member with light to form an electrostatic latent image on the surface of the electrophotographic photosensitive member; and a developing unit, which includes toner, and which is configured to develop the electrostatic latent image formed on the surface of the electrophotographic photosensitive member with the toner to form a toner image on the surface of the electrophotographic photosensitive member, wherein the electrophotographic photosensitive member includes a monolayer type photosensitive layer containing a charge generating material, a hole transporting material, an electron transporting material, and a first binder resin, wherein the photosensitive layer contains, as the first binder resin, a polyester resin having a structural unit represented by the following formula (1) and a structural unit represented by the following formula (2):

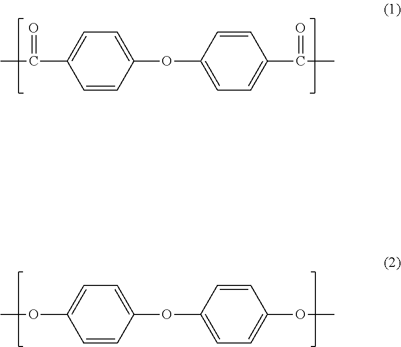

wherein the developing unit is a developing roller including a shaft body, an elastic layer arranged on an outer periphery of the shaft body, and a coating layer arranged on an outer periphery of the elastic layer, and wherein the coating layer contains a second binder resin and a silica particle.

Further features of the present invention will become apparent from the following description of exemplary embodiments with reference to the attached drawings.

### BRIEF DESCRIPTION OF THE DRAWINGS

FIG. 1 is a view for illustrating an example of a layer configuration of an electrophotographic photosensitive member used in the present invention.

FIG. 2 is a view for illustrating an example of a layer configuration of the electrophotographic photosensitive member used in the present invention.

FIG. 3 is a view for illustrating an example of a layer configuration of the electrophotographic photosensitive member used in the present invention.

FIG. 4 is a schematic perspective view for illustrating an example of a schematic configuration of a developing roller used in the present invention.

FIG. 5 is a view for illustrating an example of a schematic configuration of an electrophotographic apparatus according to the present invention.

### DESCRIPTION OF THE EMBODIMENTS

The present invention is described below in detail by way of exemplary embodiments.

According to investigations by the inventors of the present invention, in Japanese Patent Application Laid-Open No. 2019-168614, in which filming suppression is achieved by using a developing roller containing a silica particle, a decrease in transfer efficiency and toner scattering after endurance have occurred in some cases. It has been surmised that this results from a difference in chargeability of the toner occurring between portions in which the silica particle is present and absent in a surface layer of the developing roller. That is, it has been conceived that, when the difference in chargeability of the toner occurs, scattering in which part of the toner is transferred in advance before a nip portion of a transfer belt occurs, and hence image quality decreases. In addition, it has been conceived that part of the toner remains untransferred at the time of transfer, and hence transfer efficiency decreases.

Based on the above-mentioned assumption, the inventors of the present invention have made various investigations on a method of maintaining high image quality from an initial stage to a stage after endurance by suppressing a decrease in transfer efficiency and toner scattering after endurance in an electrophotographic apparatus including a developing roller containing silica in a surface layer. As a result, the inventors have achieved the configuration of the present invention.

That is, in the present invention, when a coating layer of the developing roller included in the electrophotographic apparatus is characterized by containing a binder resin and a silica particle, an electrophotographic photosensitive member included in the electrophotographic apparatus has the following configuration. The inventors of the present invention have found that, according to this configuration, high image quality can be maintained from an initial stage to a stage after endurance by suppressing a decrease in transfer efficiency and toner scattering after endurance.

First, the electrophotographic photosensitive member includes a monolayer type photosensitive layer containing a charge generating material, a hole transporting material, an electron transporting material, and a binder resin. In addition, the photosensitive layer contains, as the binder resin, a polyester resin having a structural unit represented by the following formula (1) and a structural unit represented by the following formula (2).

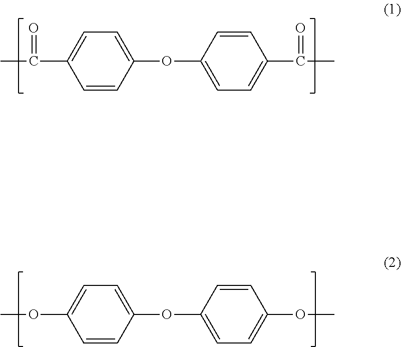

The binder resin in the photosensitive layer of the electrophotographic photosensitive member is hereinafter sometimes referred to as “first binder resin,” and the binder resin in the coating layer of the developing roller is hereinafter sometimes referred to as “second binder resin.”

The structural unit represented by the formula (1) exhibits a structure having a high electron accepting property. In addition, when the structural unit represented by the formula (1) is bonded to the structural unit represented by the formula (2), resonance is stabilized, and the electron accepting property becomes higher. It is surmised that the electrophotographic photosensitive member containing the polyester resin having the structural unit represented by the formula (1) and the structural unit represented by the formula (2) has a uniformizing effect on a potential of toner having unevenness in chargeability. That is, it is conceived that, when the monolayer type photosensitive layer contains the polyester resin having a high electron accepting property, the electrophotographic photosensitive member is relatively negatively charged to uniformize a difference in positive charge of the toner, and thus a failure at the time of transfer can be suppressed.

### [Electrophotographic Photosensitive Member]

The electrophotographic photosensitive member used in the present invention includes at least a support and a photosensitive layer formed on the support.

A method of producing the electrophotographic photosensitive member used in the present invention is, for example, a method involving: preparing coating liquids for the respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

Configurations of the electrophotographic photosensitive member are specifically described in the following.

### (Monolayer Type Photosensitive Member)

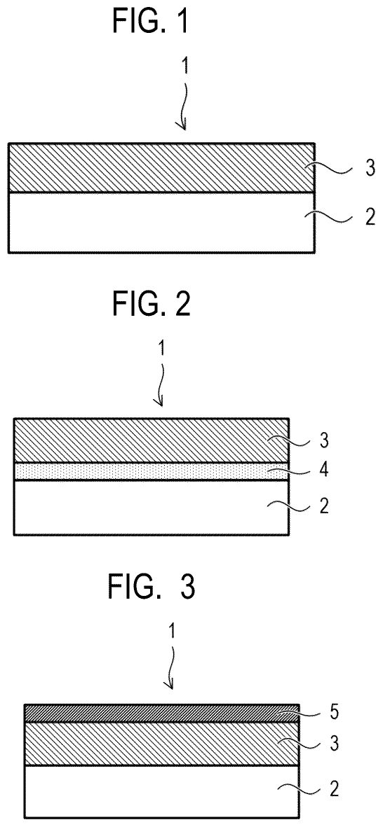

A monolayer type photosensitive member 1 which is an example of the electrophotographic photosensitive member used in the present invention is described below with reference to FIG. 1 to FIG. 3. FIG. 1 to FIG. 3 are each a partial sectional view for illustrating an example of a layer configuration of the monolayer type photosensitive member 1.

As illustrated in FIG. 1, the monolayer type photosensitive member 1 includes, for example, an electroconductive support 2 and a photosensitive layer 3. The photosensitive layer 3 included in the monolayer type photosensitive member 1 is a monolayer type photosensitive layer of a monolayer (one layer). The photosensitive layer 3 contains a charge generating material, a hole transporting material, an electron transporting material, and a first binder resin.

As illustrated in FIG. 2, the monolayer type photosensitive member 1 may further include an undercoat layer 4 (intermediate layer) in addition to the support 2 and the photosensitive layer 3. That is, in the monolayer type photosensitive member 1, the photosensitive layer may be formed directly on the support 2, or may be formed on the support 2 through intermediation of the undercoat layer 4 as illustrated in FIG. 2.

In addition, as illustrated in FIG. 3, the monolayer type photosensitive member 1 may further include a protection layer 5 in addition to the support 2 and the photosensitive layer 3. The protection layer 5 is formed on the photosensitive layer 3. In the present invention, as illustrated in each of FIG. 1 and FIG. 2, it is preferred that the monolayer type photosensitive member 1 do not include the protection layer 5 and the photosensitive layer 3 be formed as a surface layer of the monolayer type photosensitive member 1.

When the photosensitive layer 3 containing, as the first binder resin, the polyester resin having the structural unit represented by the formula (1) and the structural unit represented by the formula (2) is formed as the surface layer, a decrease in transfer efficiency and toner scattering after endurance are easily suppressed.

The thickness of the photosensitive layer 3 is not particularly limited, but is preferably 5 μm or more and 100 μm or less, more preferably 10 μm or more and 50 μm or less.

### <Support>

In the present invention, the electrophotographic photosensitive member includes the support. In the present invention, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Undercoat Layer>

In the present invention, an undercoat layer may be arranged on the support. The arrangement of the undercoat layer can improve an adhesive function between layers to impart a charge injection inhibiting function.

The undercoat layer preferably contains a resin. In addition, the undercoat layer may be formed as a cured film by polymerizing a composition containing a monomer having a polymerizable functional group.

Examples of the resin include a polyester resin, a polyarylate resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron transporting material, a metal oxide, a metal, an electroconductive polymer, and the like for the purpose of improving electric characteristics. Of those, an electron transporting material and a metal oxide are preferably used.

Examples of the electron transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting material having a polymerizable functional group may be used as the electron transporting material and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The thickness of the undercoat layer is preferably from 0.1 μm to 50 μm, more preferably from 0.2 μm to 40 μm, particularly preferably from 0.3 μm to 30 μm.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Monolayer Type Photosensitive Layer>

The electrophotographic photosensitive member used in the present invention includes the monolayer type photosensitive layer arranged on the support, or on the undercoat layer arranged on the support.

In the present invention, the monolayer type photosensitive layer is constituted with containing at least, a first binder resin, a charge generating material, a hole transporting material, and an electron transporting material.

### [First Binder Resin]

The first binder resin to be used in the photosensitive layer contains a polyester resin having a structural unit represented by the formula (1) and a structural unit represented by the formula (2).

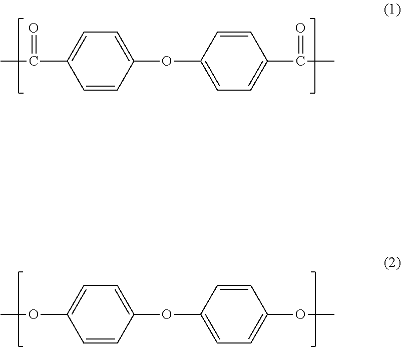

The structural unit represented by the formula (1) is a structure having a high electron accepting property. In addition, when the structural unit represented by the formula (1) is bonded to the structural unit represented by the formula (2), resonance is stabilized, and the electron accepting property becomes higher. Accordingly, it is conceived that an electrophotographic photosensitive member including the photosensitive layer containing the polyester resin having the structural unit represented by the formula (1) and the structural unit represented by the formula (2) enhances the positive chargeability of the toner. Specifically, the inventors of the present invention have conceived that, when the positively charged toner is developed on the electrophotographic photosensitive member and transferred to a transfer target member, the electrophotographic photosensitive member is relatively negatively charged to have a uniformizing effect on a difference in positive charge of the toner.

Further, the polyester resin may have a structural unit represented by the following formula (4) and a structural unit represented by the following formula (5) in addition to the structural unit represented by the formula (1) and the structural unit represented by the formula (2).

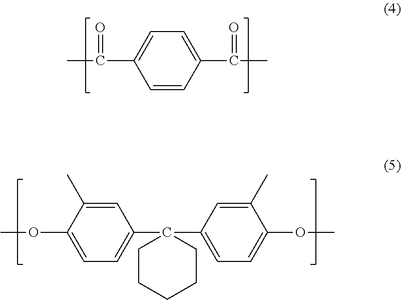

When the polyester resin having the structural unit represented by the formula (1) and the structural unit represented by the formula (2) further has the structural unit represented by the formula (4) and the structural unit represented by the formula (5), the solubility of the above-mentioned polyester resin in a solvent is improved. Accordingly, the photosensitive layer can be satisfactorily formed.

The above-mentioned polyester resin may be, for example, a random copolymer, an alternating copolymer, a periodic copolymer, or a block copolymer.

In the above-mentioned polyester resin, the ratio of the substance amount in terms of mole of the structural unit represented by the formula (1) with respect to the sum of the substance amounts in terms of mole of the structural units constituting the polyester resin is represented by M1. In addition, the ratio of the substance amount in terms of mole of the structural unit represented by the formula (2) with respect to the sum of the substance amounts in terms of mole of the structural units constituting the polyester resin is represented by M2. In addition, the ratio of the substance amount in terms of mole of the structural unit represented by the formula (4) with respect to the sum of the substance amounts in terms of mole of the structural units constituting the polyester resin is represented by M4. In addition, the ratio of the substance amount in terms of mole of the structural unit represented by the formula (5) with respect to the sum of the substance amounts in terms of mole of the structural units constituting the polyester resin is represented by M5. In this case, M1/(M1+M4) is preferably more than 0.30, more preferably 0.55 or more from the viewpoint of suppressing a decrease in transfer efficiency.

A mole fraction of M2/(M2+M5) is preferably larger from the viewpoint of suppressing a decrease in transfer efficiency, and is preferably 0 or more and 0.50 or less from the viewpoint of solubility in a solvent. When the solubility in a solvent is improved, the photosensitive layer can be satisfactorily formed.

M4/(M1+M4) is preferably 0.30 or more and 0.70 or less from the viewpoint of solubility in a solvent.

M5/(M2+M5) is preferably less than 0.70 from the viewpoint of suppressing a decrease in transfer efficiency, and is preferably more than 0.50 from the viewpoint of solubility in a solvent.

Further, it is preferred that M4/(M1+M4) be 0.30 or more and 0.70 or less, and M2/(M2+M5) be 0 or more and 0.50 or less.

In the above-mentioned polyester resin, when the sum of the substance amounts in terms of mole of structural units derived from dicarboxylic acids, the structural units constituting the polyester resin is represented by MC and the substance amount of the structural unit represented by the formula (1) constituting the polyester resin is represented by M1, M1/MC is preferably 0.50 or more.

The viscosity-average molecular weight of the above-mentioned polyester resin is preferably 10,000 or more, more preferably 30,000 or more, still more preferably 50,000 or more. When the viscosity-average molecular weight of the above-mentioned polyester resin is 10,000 or more, the wear resistance of the photosensitive member is improved. Meanwhile, the viscosity-average molecular weight of the above-mentioned polyester resin is preferably 80,000 or less, more preferably 70,000 or less. When the viscosity-average molecular weight of the above-mentioned polyester resin is 80,000 or less, the above-mentioned polyester resin is easily dissolved in a solvent for forming a photosensitive layer.

Examples of the bisphenols for forming bisphenol-derived repeating units in the above-mentioned polyester resin include a compound represented by the following formula (BP-2) and a compound represented by the following formula (BP-5). The compound represented by the following formula (BP-2) is hereinafter sometimes referred to as “compound (BP-2).” In addition, the compound represented by the following formula (BP-5) is hereinafter sometimes referred to as “compound (BP-5).”

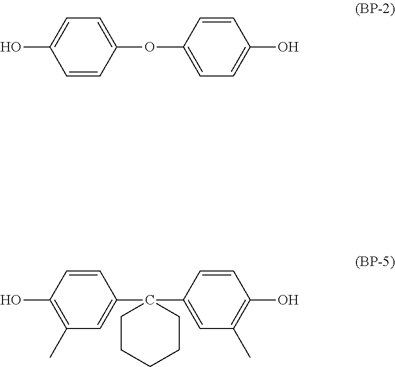 [SMILES: Oc1ccc(Oc2ccc(O)cc2)cc1 ; Cc1cc(C2(c3ccc(O)c(C)c3)CCCCC2)ccc1O]

In addition, examples of the dicarboxylic acids for forming dicarboxylic acid-derived repeating units in the above-mentioned polyester resin include a compound represented by the following formula (DC-1) and a compound represented by the following formula (DC-4). The compound represented by the following formula (DC-1) is hereinafter sometimes referred to as “compound (DC-1).” In addition, the compound represented by the following formula (DC-4) is hereinafter sometimes referred to as “compound (DC-4).”

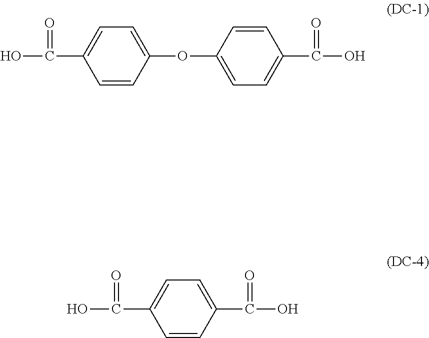 [SMILES: O=C(O)c1ccc(Oc2ccc(C(=O)O)cc2)cc1 ; O=C(O)c1ccc(C(=O)O)cc1]

A bisphenol ratio in the resin may be adjusted by changing the amounts of the compound (BP-2) and the compound (BP-5) to be added at the time of production of the above-mentioned polyester resin. In addition, a dicarboxylic acid ratio in the resin may be similarly adjusted by changing the amounts of the compound (DC-1) and the compound (DC-4) to be added at the time of production of the above-mentioned polyester resin.

The bisphenols (e.g., the compounds (BP-2) and (BP-5)) may each be used by being derivatized into an aromatic diacetate. The dicarboxylic acids (e.g., the compounds (DC-1) and (DC-4)) may each be used by being derivatized. Examples of the derivative of the dicarboxylic acid include a dicarboxylic acid dichloride, a dicarboxylic acid dimethyl ester, a dicarboxylic acid diethyl ester, and a dicarboxylic acid anhydride. The dicarboxylic acid dichloride is a compound having a structure in which two “—C(═O)—OH” groups of the dicarboxylic acid are each substituted with a “—C(—O)—Cl” group.

In the polycondensation of the bisphenol and the dicarboxylic acid, one or both of a base and a catalyst may be added. An example of the base is sodium hydroxide. Examples of the catalyst include benzyltributylammonium chloride, ammonium chloride, ammonium bromide, a quaternary ammonium salt, triethylamine, and trimethylamine.

The photosensitive layer may contain, as the first binder resin, only the above-mentioned polyester resin, and may further contain a binder resin other than the foregoing (hereinafter sometimes referred to as “other binder resin”) within a range that does not impair the effects of the present invention.

Examples of the other binder resin include: thermoplastic resins (more specifically, a polyester resin other than the above-mentioned polyester resin, a polycarbonate resin, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallyl phthalate resin, a ketone resin, a polyvinyl butyral resin, a polyvinyl acetal resin, and a polyether resin); thermosetting resins (more specifically, a silicone resin, an epoxy resin, a phenol resin, a urea resin, a melamine resin, and any other crosslinkable thermosetting resin); and photocurable resins (more specifically, an epoxy-acrylic acid-based resin and a urethane-acrylic acid-based copolymer).

The first binder resin in the photosensitive layer preferably contains 50 mass % or more of the polyester resin having the structural unit represented by the formula (1) and the structural unit represented by the formula (2). That is, the content ratio of the above-mentioned polyester resin is preferably 50 mass % or more with respect to the total mass of the first binder resin.

The structure of the polyester resin used in the present invention may be determined by a ¹H-nuclear magnetic resonance spectrum obtained by performing component analysis of polymer components recovered from the photosensitive layer through use of ¹H-nuclear magnetic resonance spectrometry in deuterated chloroform.

An example of a specific analysis method is described below.

### (Reprecipitation of Resin in Photosensitive Layer)

The photosensitive member (also referred to as simply “drum” in the following) is cut.

The drum is cut at a position 10 cm distant from an end portion of the drum in a generating line direction with a scroll saw.
An inner surface of the cut drum of 10 cm is cleaned.

The inner surface is wiped with lens cleaning paper impregnated with chloroform.

### Elute the Photosensitive Layer

3 cm of an end portion of the cut drum is immersed in chloroform.

(About 60 ml of chloroform is loaded into a 100 ml beaker, and the end portion is immersed therein at normal temperature for 5 minutes.)

### Concentrate (Concentrate Liquefy)

Concentration to 2 mL is carried out with a rotary evaporator, and the concentration is stopped.

### Perform Reprecipitation

50 mL of a methanol/acetone mixed solution (volume ratio: 1:1) is prepared, and the whole amount of the above-mentioned concentrated solution is dropped thereinto while the mixed solution is stirred.

### Filtrate

Suction filtration is performed with a Kiriyama funnel (funnel: SU-40, paper filter: No. 5C-40, manufactured by Kiriyama Glass Co.).

### Dry

The residue on the paper filter is recovered with a spatula and dried in a vacuum (70° C., 1 hour).

### (NMR Measurement)

### Prepare a Measurement Sample

20 mg of a sample is dissolved in 1 g of deuterated chloroform containing tetramethylsilane serving as a reference material, and the whole amount thereof is transferred to an NMR tube.

(Deuterated chloroform: manufactured by Sigma-Aldrich Japan G.K., chloroform-d, model number: 612200)
(NMR tube: manufactured by Norell, Inc., ST500-7, model number: S3010)

### NMR Measurement

Apparatus: AVANCE 500 manufactured by Bruker

Conditions: Proton NMR, automatic measurement by Icon-NMR

Number of scans: 32

Reference peak: The peak of a methyl group of tetramethylsilane is set to 0 ppm.

### [Charge Generating Material]

Examples of the charge generating material include a phthalocyanine-based pigment, a perylene-based pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, powder of an inorganic photoconductive material (e.g., selenium, selenium-tellurium, selenium-arsenic, cadmium sulfide, and amorphous silicon), a pyrylium pigment, an anthanthrone-based pigment, a triphenylmethane-based pigment, a threne-based pigment, a toluidine-based pigment, a pyrazoline-based pigment, and a quinacridone-based pigment. The photosensitive layer may contain only one kind of charge generating material, or may contain two or more kinds of charge generating materials.

The phthalocyanine-based pigment is a pigment having a phthalocyanine structure. Examples of the phthalocyanine-based pigment include metal-free phthalocyanine and a metal phthalocyanine. Examples of the metal phthalocyanine include titanyl phthalocyanine, hydroxygallium phthalocyanine, and chlorogallium phthalocyanine. The metal phthalocyanine is preferably titanyl phthalocyanine. Titanyl phthalocyanine is represented by the following formula (CGM-1).

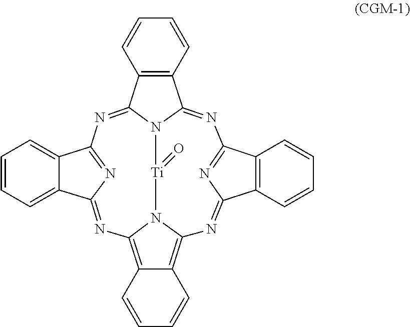

The phthalocyanine-based pigment may be crystalline or amorphous. An example of the crystal of metal-free phthalocyanine is an X-form crystal of metal-free phthalocyanine (hereinafter sometimes referred to as “X-form metal-free phthalocyanine”). Examples of the crystal of titanyl phthalocyanine include α-form, β-form, and Y-form crystals of titanyl phthalocyanine (hereinafter sometimes referred to as “α-form, β-form, and Y-form titanyl phthalocyanines,” respectively).

For example, in a digital optical electrophotographic apparatus (e.g., a laser beam printer or a facsimile using a light source such as a semiconductor laser), a photosensitive member having sensitivity in a wavelength region of 700 nm or more is preferably used. The charge generating material is preferably a phthalocyanine-based pigment, more preferably metal-free phthalocyanine or titanyl phthalocyanine, because these materials each have a high quantum yield in a wavelength region of 700 nm or more. In addition, the charge generating material is still more preferably titanyl phthalocyanine, particularly preferably Y-form titanyl phthalocyanine.

The Y-form titanyl phthalocyanine does not have a peak at 26.2°, and has a main peak, for example, at a Bragg angle (2θ±0.2°) of 27.2° in a CuKα characteristic X-ray diffraction spectrum. The main peak in the CuKα characteristic X-ray diffraction spectrum is a peak having the first or second largest intensity in the range of a Bragg angle (2θ±0.2°) of 3° or more and 40° or less.

The CuKα characteristic X-ray diffraction spectrum may be measured, for example, by the following method. First, a sample (titanyl phthalocyanine) is loaded into a sample holder of an X-ray diffraction apparatus (e.g., “RINT (trademark) 1100” manufactured by Rigaku Corporation). Subsequently, an X-ray diffraction spectrum is measured under the conditions of an X-ray tube bulb of Cu, a tube voltage of 40 kV, a tube current of 30 mA, and a CuKα characteristic X-ray wavelength of 1.542 Å. A measurement range (2θ) is, for example, 3° or more and 40° or less (start angle: 3° and stop angle:) 40°, and a scanning speed is, for example, 10°/min. The main peak is determined from the resultant X-ray diffraction spectrum, and the Bragg angle of the main peak is read.

The content of the charge generating material in the photosensitive layer is preferably 0.1 part by mass or more and 50 parts by mass or less, more preferably 0.5 part by mass or more and 5 parts by mass or less with respect to 100 parts by mass of the binder resin.

### [Electron Transporting Material]

It is preferred that the electron transporting material contain at least one compound selected from the group consisting of: a compound represented by the following formula (10); a compound represented by the following formula (11); a compound represented by the following formula (12); a compound represented by the following formula (13); a compound represented by the following formula (14); a compound represented by the following formula (15); and a compound represented by the following formula (16). It is conceived that, when the photosensitive layer contains the above-mentioned electron transporting material, the compatibility between the above-mentioned polyester resin and a hole transporting material described later is increased to enhance the uniformity in the photosensitive layer, and thus the effects of the present invention are highly achieved.

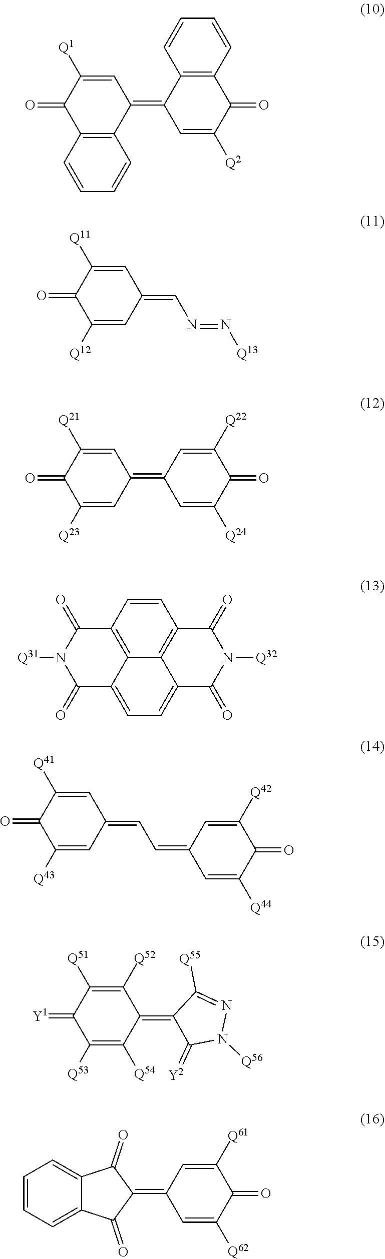

Q¹ and Q² in the formula (10), Q¹¹, Q¹², and Q¹³ in the formula (11), Q²¹, Q²², Q²³, and Q²⁴ in the formula (12), Q³¹ and Q³² in the formula (13), Q⁴¹, Q⁴², Q⁴³, and Q⁴⁴ in the formula (14), Q⁵¹, Q⁵², Q⁵³, Q⁵⁴, Q⁵⁵, and Q⁵⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom. Y¹ and Y² in the formula (15) each independently represent an oxygen atom or a sulfur atom.

It is preferred that Q¹ and Q² in the formula (10), Q¹¹ to Q¹³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16) each independently represent a hydrogen atom, an alkyl group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom. It is preferred that Y¹ and Y² in the formula (15) each represent an oxygen atom.

The alkyl group having 1 or more and 6 or less carbon atoms, which is represented by each of Q¹ and Q² in the formula (10), Q¹¹ to Q¹³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16), is preferably an alkyl group having 1 or more and 5 or less carbon atoms, preferably a methyl group, an ethyl group, a propyl group, a butyl group, or a pentyl group, particularly preferably a methyl group, an isopropyl group, a tert-butyl group, or a 1,1-dimethylpropyl group.

The aryl group having 6 or more and 14 or less carbon atoms, which is represented by each of Q¹ and Q² in the formula (10), Q¹¹ to Q¹³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16), is preferably an aryl group having 6 or more and 10 or less carbon atoms, more preferably a phenyl group.

Here, the alkyl group having 1 or more and 6 or less carbon atoms that the aryl group having 6 or more and 14 or less carbon atoms may have as a substituent is preferably an alkyl group having 1 or more and 3 or less carbon atoms, more preferably a methyl group or an ethyl group.

In addition, the halogen atom that the aryl group having 6 or more and 14 or less carbon atoms may have as a substituent is preferably a fluorine atom, a chlorine atom, or a bromine atom, particularly preferably a chlorine atom.

When the aryl group having 6 or more and 14 or less carbon atoms is substituted with a substituent, the number of substituents is preferably 1 or more and 5 or less, more preferably 1 or 2.

The aryl group having 6 or more and 14 or less carbon atoms that is substituted with at least one substituent selected from the group consisting of: an alkyl group having 1 or more and 6 or less carbon atoms; and a halogen atom is preferably a chlorophenyl group, a dichlorophenyl group, or an ethylmethylphenyl group, more preferably a 4-chlorophenyl group, a 2,5-dichlorophenyl group, or a 2-ethyl-6-methylphenyl group.

A suitable example of the compound represented by the formula (10) is a compound represented by the following formula (E-4). A suitable example of the compound represented by the formula (11) is a compound represented by the following formula (E-5). A suitable example of the compound represented by the formula (12) is a compound represented by the following formula (E-7). A suitable example of the compound represented by the formula (13) is a compound represented by the following formula (E-6). A suitable example of the compound represented by the formula (14) is a compound represented by the following formula (E-8). Suitable examples of the compound represented by the formula (15) include a compound represented by the following formula (E-2) and a compound represented by the following formula (E-3). A suitable example of the compound represented by the formula (16) is a compound represented by the following formula (E-1). The compounds represented by the formulae (E-1) to (E-8) are hereinafter sometimes referred to as “electron transporting materials (E-1) to (E-8),” respectively.

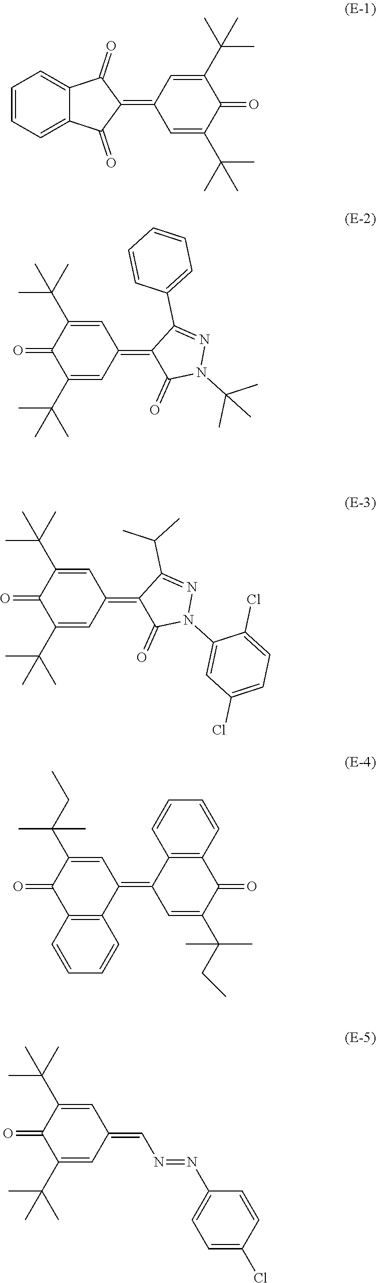

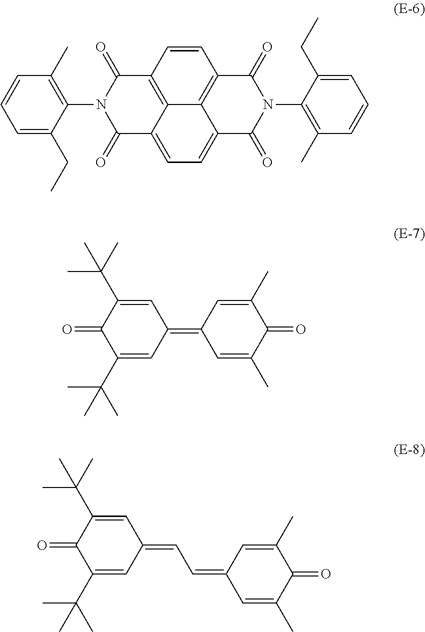

The content of the electron transporting material in the photosensitive layer is preferably 5 parts by mass or more and 150 parts by mass or less, more preferably 10 parts by mass or more and 100 parts by mass or less, still more preferably 30 parts by mass or more and 70 parts by mass or less with respect to 100 parts by mass of the binder resin. The photosensitive layer may contain only one kind of electron transporting material, or may contain two or more kinds of electron transporting materials.

### [Hole Transporting Material]

At least one compound selected from the group consisting of: a compound represented by the following formula (20); a compound represented by the following formula (21); a compound represented by the following formula (22); a compound represented by the following formula (23); and a compound represented by the following formula (24) is preferably included as the hole transporting material. It is conceived that the incorporation of the above-mentioned hole transporting material into the photosensitive layer increases the compatibility between the polyester resin and the electron transporting material to increase the homogeneity of the inside of the photosensitive layer, to thereby enhance the effects of the present disclosure.

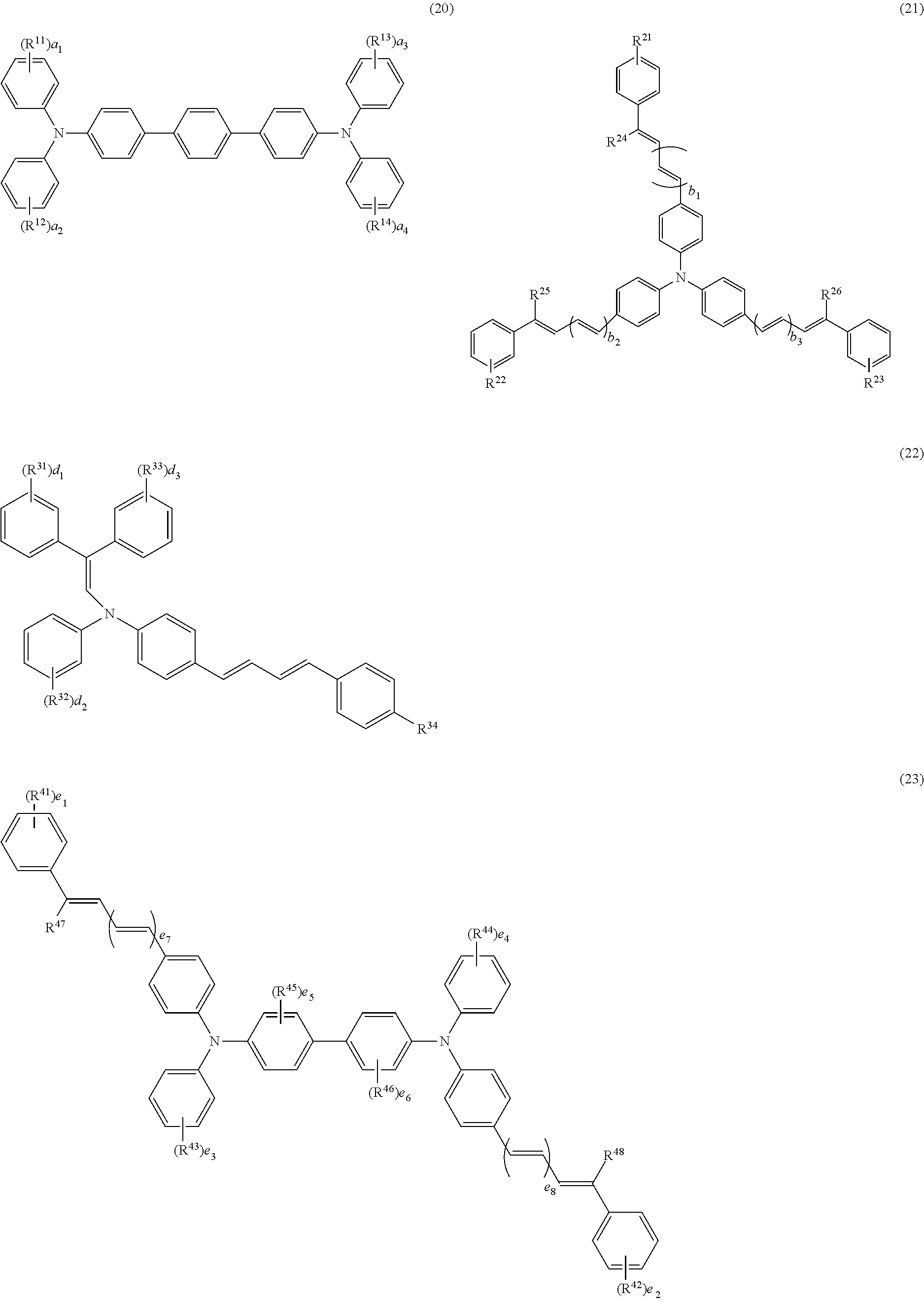

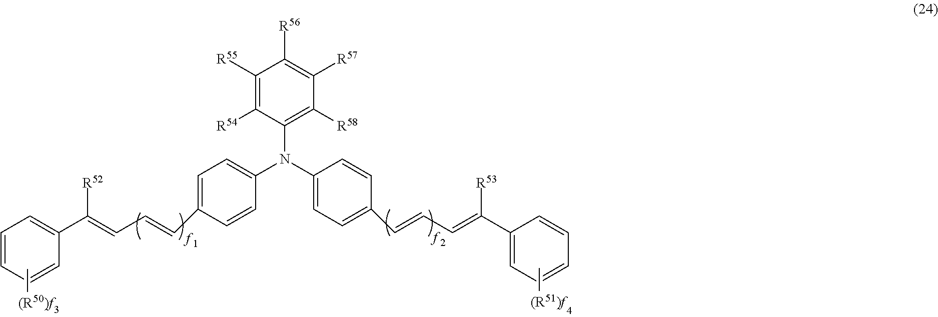

In the formula (20), R¹¹, R¹², R¹³, and R¹⁴ each independently represent an alkyl group having 1 or more and 6 or less carbon atoms, or an alkoxy group having 1 or more and 6 or less carbon atoms, and a₁, a₂, a₃, and as each independently represent an integer of 0 or more and 5 or less. In the formula (21), R²¹, R²², and R²³ each independently represent an alkyl group having 1 or more and 6 or less carbon atoms, R²⁴, R²⁵, and R²⁶ each independently represent a hydrogen atom, or an alkyl group having 1 or more and 6 or less carbon atoms, and b₁, b₂, and b₃ each independently represent 0 or 1. In the formula (22), R³¹, R³², and R³³ each independently represent an alkyl group having 1 or more and 6 or less carbon atoms, R³⁴ represents an alkyl group having 1 or more and 6 or less carbon atoms, or a hydrogen atom, and d₁, d₂, and d₃ each independently represent an integer of 0 or more and 5 or less. In the formula (23), R⁴¹, R⁴², R⁴³, R⁴⁴, R⁴⁵, and R⁴⁶ each independently represent an alkyl group having 1 or more and 6 or less carbon atoms, or a phenyl group, R⁴⁷ and R⁴⁸ each independently represent a hydrogen atom, an alkyl group having 1 or more and 6 or less carbon atoms, or a phenyl group, e₁, e₂, e₃, and e₄ each independently represent an integer of 0 or more and 5 or less, e₅ and e₆ each independently represent an integer of 0 or more and 4 or less, and e₇ and e₅ each independently represent 0 or 1. In the formula (24), R⁵⁰ and R⁵¹ each independently represent an alkyl group having 1 or more and 6 or less carbon atoms, an alkoxy group having 1 or more and 6 or less carbon atoms, or a phenyl group, R⁵², R⁵³, R⁵⁴, R⁵⁵, R⁵⁶, R⁵⁷, and R³⁸ each independently represent a hydrogen atom, an alkyl group having 1 or more and 6 or less carbon atoms, an alkoxy group having 1 or more and 6 or less carbon atoms, or a phenyl group that may be substituted with an alkyl group having 1 or more and 6 or less carbon atoms, f₁ and f₂ each independently represent an integer of 0 or more and 2 or less, and f₃ and f₄ each independently represent an integer of 0 or more and 5 or less.

In the formula (20), when a₁ represents an integer of 2 or more and 5 or less, a plurality of R¹¹s may represent groups identical to or different from each other. When az represents an integer of 2 or more and 5 or less, a plurality of R¹²s may represent groups identical to or different from each other. When a₃ represents an integer of 2 or more and 5 or less, a plurality of R¹³s may represent groups identical to or different from each other. When a₄ represents an integer of 2 or more and 5 or less, a plurality of R¹⁴s may represent groups identical to or different from each other. In the formula (20), R¹¹, R¹², R¹³, and R¹⁴ each independently represent preferably an alkyl group having 1 or more and 3 or less carbon atoms, more preferably a methyl group or an ethyl group. a₁, a₂, a₃, and a₄ each independently represent preferably an integer of 1 or more and 3 or less, more preferably 1.

In the formula (21), R²¹, R²², and R²³ each independently represent preferably an alkyl group having 1 or more and 3 or less carbon atoms, more preferably a methyl group. The bonding position of each of R²¹, R²², and R²³ in a phenyl group is preferably a meta-position with respect to the bonding position of an ethenyl group or a butadienyl group. R²⁴, R²⁵, and R²⁶ each preferably represent a hydrogen atom. It is preferred that b₁, b₂, and b₃ all represent 0 or all represent 1.

In the formula (22), when d₁ represents an integer of 2 or more and 5 or less, a plurality of R³¹s may represent groups identical to or different from each other. When d₂ represents an integer of 2 or more and 5 or less, a plurality of R³²s may represent groups identical to or different from each other. When d₃ represents an integer of 2 or more and 5 or less, a plurality of R³³s may represent groups identical to or different from each other. In the formula (22), R³⁴ preferably represents a hydrogen atom. d₁, d₂, and d₃ each preferably represent 0.

In the formula (23), when e₁ represents an integer of 2 or more and 5 or less, a plurality of R⁴¹s may represent groups identical to or different from each other. When e₂ represents an integer of 2 or more and 5 or less, a plurality of R⁴²s may represent groups identical to or different from each other. When e₃ represents an integer of 2 or more and 5 or less, a plurality of R⁴³s may represent groups identical to or different from each other. When e₄ represents an integer of 2 or more and 5 or less, a plurality of R⁴⁴s may represent groups identical to or different from each other. When e₅ represents an integer of 2 or more and 4 or less, a plurality of R⁴⁵s may represent groups identical to or different from each other. When e₆ represents an integer of 2 or more and 4 or less, a plurality of R⁴⁶s may represent groups identical to or different from each other. In the formula (23), R⁴¹ to R⁴⁶ each independently represent preferably an alkyl group having 1 or more and 6 or less carbon atoms, more preferably an alkyl group having 1 or more and 3 or less carbon atoms, still more preferably a methyl group or an ethyl group. R⁴⁷ and R⁴⁸ each preferably represent a hydrogen atom. It is preferred that e₁, e₂, e₃, and e₄ each independently represent an integer of 0 or more and 2 or less. It is more preferred that e₁ and e₂ each represent 0, and e₃ and e₄ each represent 2. e₅ and e₆ each preferably represent 0. It is preferred that e₇ and e₅ all represent 0 or all represent 1.

In the formula (24), when f₃ represents an integer of 2 or more and 5 or less, a plurality of R⁵⁰s may represent groups identical to or different from each other. When f₄ represents an integer of 2 or more and 5 or less, a plurality of R⁵¹s may represent groups identical to or different from each other. In the formula (24), it is preferred that R⁵⁰ and R₅₁ each independently represent an alkyl group having 1 or more and 6 or less carbon atoms. It is preferred that R₅₂ and R₅₃ each represent a hydrogen atom, or a phenyl group that may be substituted with an alkyl group having 1 or more and 6 or less carbon atoms. It is preferred that R⁵⁴ to R⁵⁸ each independently represent a hydrogen atom, an alkyl group having 1 or more and 6 or less carbon atoms, or an alkoxy group having 1 or more and 6 or less carbon atoms. It is preferred that f₁ and f₂ all represent 0, all represent 1, or all represent 2. It is preferred that f₃ and f₄ each independently represent 0 or 1. The alkyl group having 1 or more and 6 or less carbon atoms represented by R⁵⁰ and R⁵¹ is preferably an alkyl group having 1 or more and 3 or less carbon atoms, more preferably a methyl group. The phenyl group that may be substituted with an alkyl group having 1 or more and 6 or less carbon atoms represented by R⁵² and R⁵³ is preferably a phenyl group, or a phenyl group that is substituted with an alkyl group having 1 or more and 3 or less carbon atoms. The phenyl group that is substituted with an alkyl group having 1 or more and 3 or less carbon atoms is preferably a methylphenyl group, more preferably a 4-methylphenyl group. The alkyl group having 1 or more and 6 or less carbon atoms represented by R⁵⁴ to R⁵⁸ is preferably an alkyl group having 1 or more and 4 or less carbon atoms, more preferably a methyl group, an ethyl group, or a n-butyl group. The alkoxy group having 1 or more and 6 or less carbon atoms represented by R⁵⁴ to R⁵⁸ is preferably an alkoxy group having 1 or more and 3 or less carbon atoms, more preferably an ethoxy group.

A suitable example of the compound represented by the formula (20) is a compound represented by a following formula (H-11). Suitable examples of the compound represented by the formula (21) include a compound represented by a following formula (H-7) and a compound represented by a following formula (H-8). A suitable example of the compound represented by the formula (22) is a compound represented by a following formula (H-6). Suitable examples of the compound represented by the formula (23) include a compound represented by a following formula (H-9) and a compound represented by a following formula (H-10). Suitable examples of the compound represented by the formula (24) include a compound represented by a following formula (H-1), a compound represented by a following formula (H-2), a compound represented by a following formula (H-3), a compound represented by a following formula (H-4), and a compound represented by a following formula (H-5). The compounds represented by the formulae (H-1) to (H-11) are hereinafter sometimes referred to as “hole transporting materials (H-1) to (H-11),” respectively.

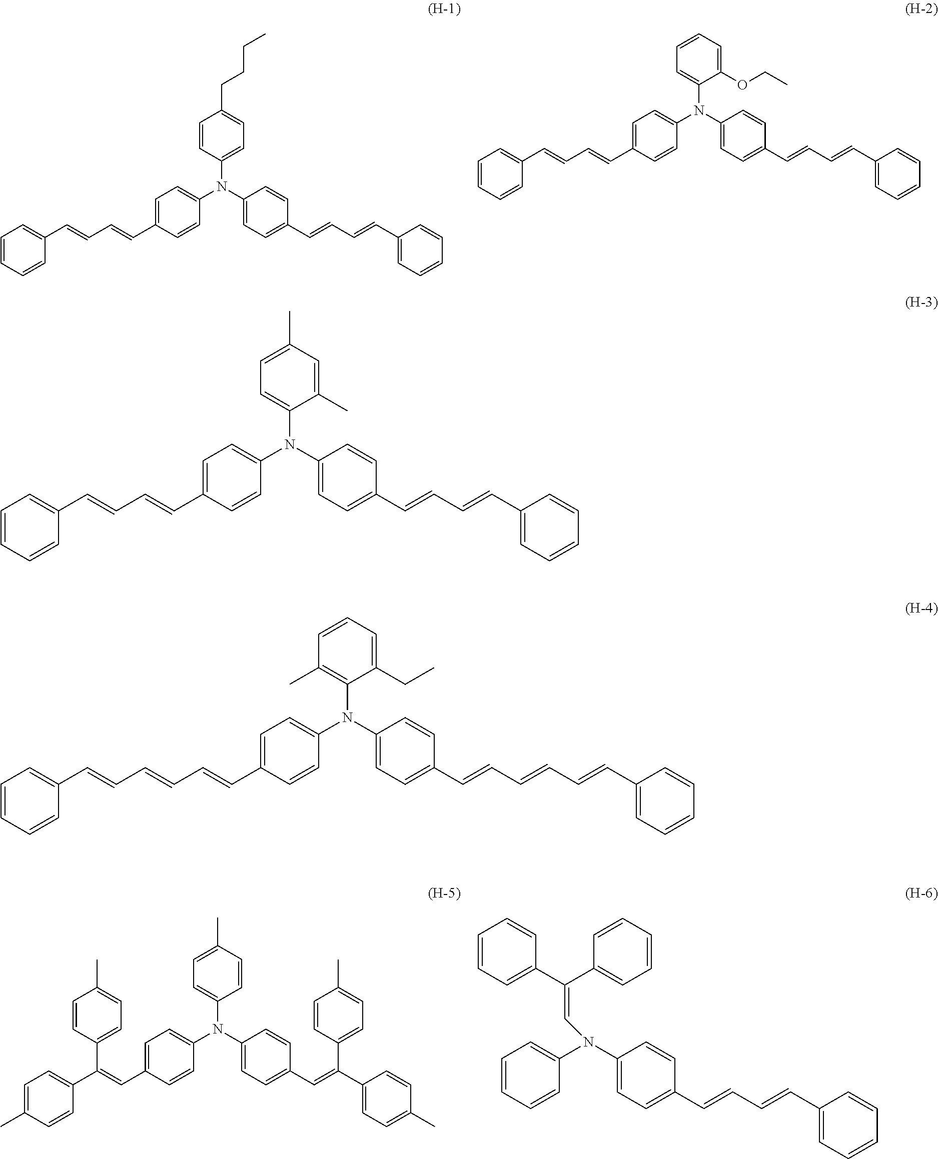

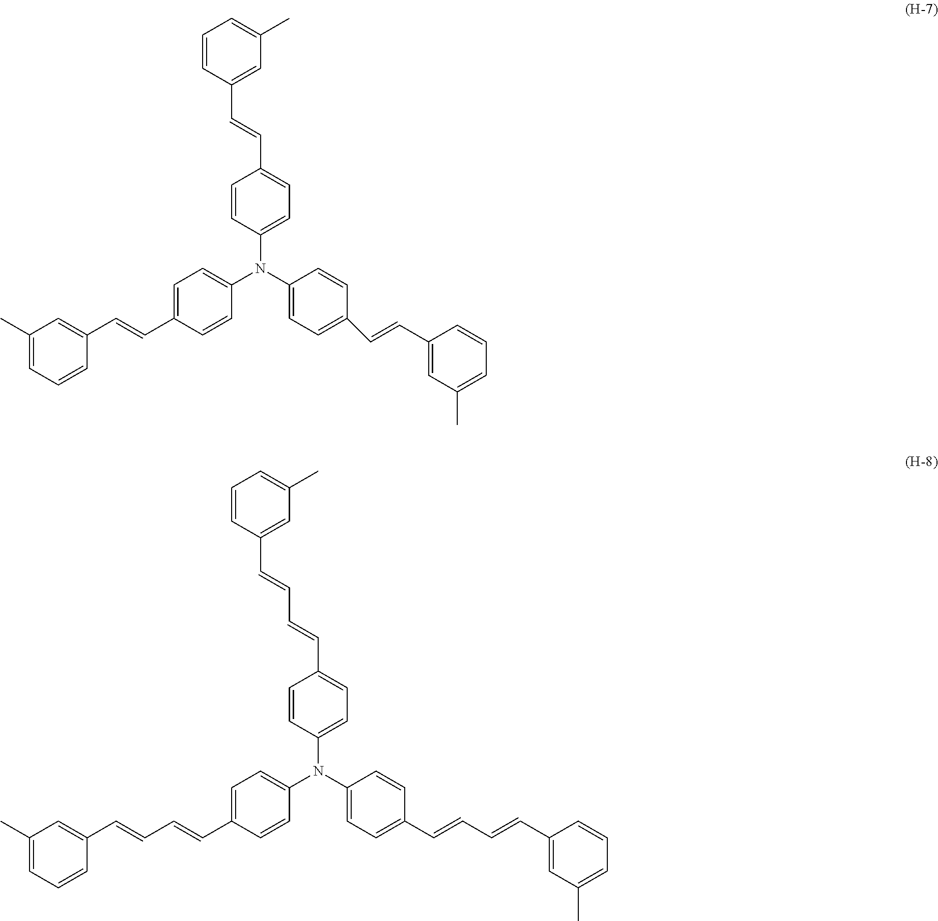 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

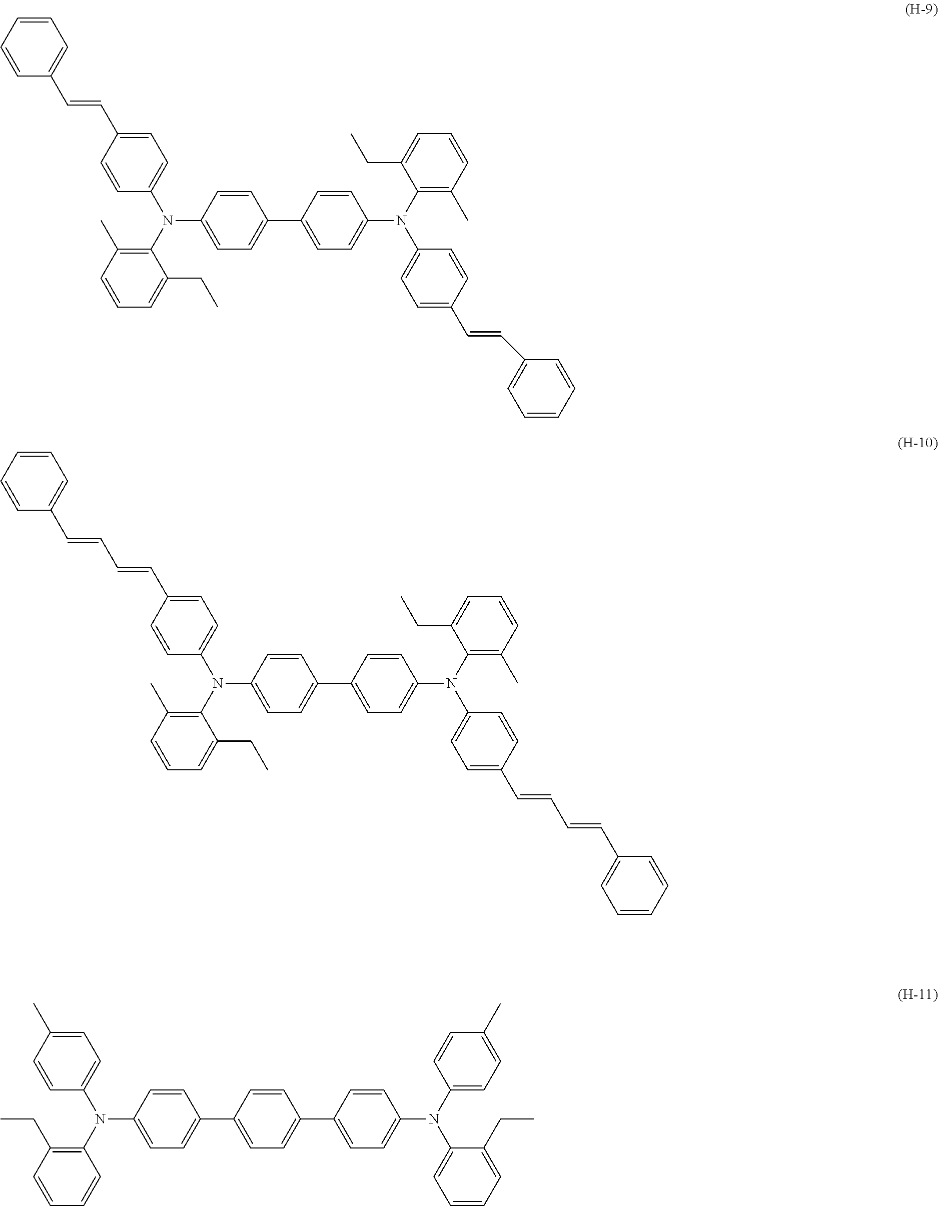 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

The content of the hole transporting material in the photosensitive layer is preferably 10 parts by mass or more and 200 parts by mass or less, more preferably 30 parts by mass or more and 120 parts by mass or less, still more preferably 50 parts by mass or more and 90 parts by mass or less with respect to 100 parts by mass of the binder resin.

The photosensitive layer may contain only one kind of hole transporting material, or may contain two or more kinds of hole transporting materials. In addition, the photosensitive layer may further contain a hole transporting material other than the compounds each represented by any of the formula (20), (21), (22), (23), and (24) (hereinafter sometimes referred to as “other hole transporting material”). Examples of the other hole transporting material include triphenylamine derivatives, diamine derivatives (e.g., N,N,N′,N′-tetraphenylbenzidine derivatives, N,N,N′,N′-tetraphenylphenylenediamine derivatives, N,N,N′,N′-tetraphenylnaphthylenediamine derivatives, N,N,N′,N′-tetraphenylphenanthrylenediamine derivatives, and di(aminophenylethenyl)benzene derivatives), oxadiazole-based compounds (e.g., 2,5-di(4-methylaminophenyl)-1,3,4-oxadiazole), styryl-based compounds (e.g., 9-(4-diethylaminostyryl) anthracene), carbazole-based compounds (e.g., polyvinylcarbazole), organic polysilane compounds, pyrazoline-based compounds (e.g., 1-phenyl-3-(p-dimethylaminophenyl) pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

### [Additive]

The photosensitive layer may contain an additive as required. Examples of the additive include a UV absorber, an antioxidant, a radical scavenger, a singlet quencher, a softener, a surface modifier, an extender, a thickener, a wax, a donor, a surfactant, a plasticizer, a sensitizer, and a leveling agent. In particular, it is preferred that the photosensitive layer contain a compound represented by the following formula (T-1).

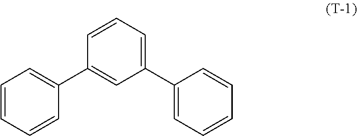 [SMILES: c1ccc(-c2cccc(-c3ccccc3)c2)cc1]

### [Developing Roller]

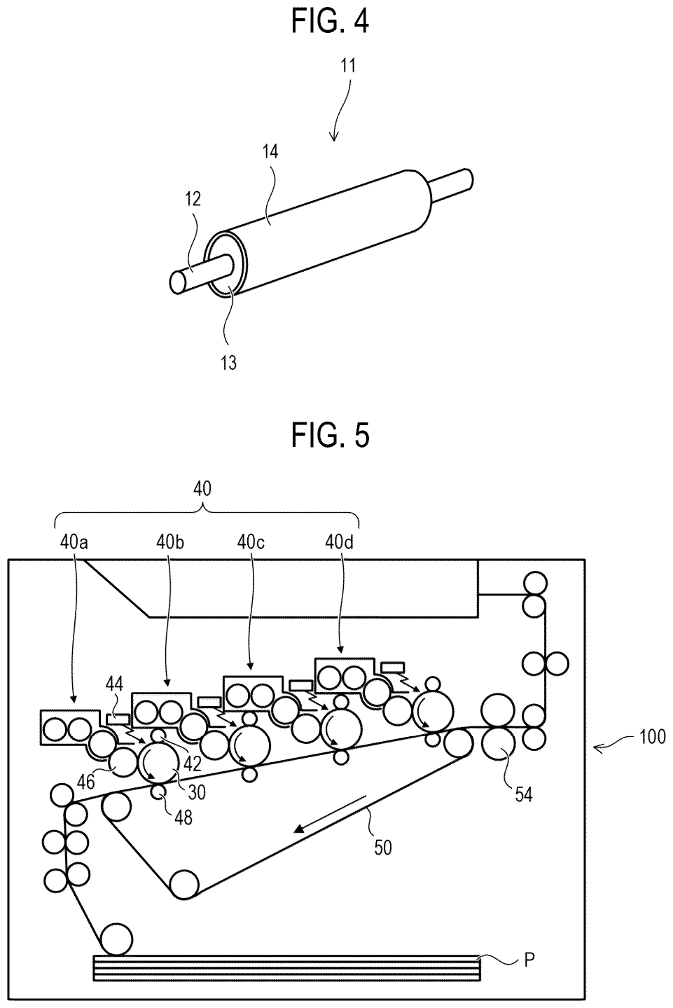

The developing roller used in the present invention is specifically described below with reference to FIG. 4. FIG. 4 is a view for illustrating an example of a schematic configuration of the developing roller used in the present invention.

[Shaft body]

A shaft body having electroconductivity to be used in a hitherto known developing roller may be preferably used as a shaft body 12. The shaft body 12 is preferably formed of, for example, at least one kind of metal selected from the group consisting of: iron; aluminum; stainless steel; and brass. The shaft body 12 formed of such metal is also generally known as the name “metal core.”

The shaft body 12 may also be a shaft body containing an insulating resin. The insulating resin may be, for example, a thermoplastic resin or a thermosetting resin. The shaft body 12 may be, for example, a shaft body including a core body formed of the insulating resin, and a plating layer arranged on the core body. Such shaft body 12 may be obtained by, for example, subjecting the core body formed of the insulating resin to plating to impart electroconductivity.

The shaft body 12 is preferably a metal core for obtaining satisfactory electroconductivity.

The shape of the shaft body 12 is preferably, for example, a rod shape or a tube shape. The sectional shape of the shaft body 12 may be, for example, a circular shape or an elliptical shape, or a non-circular shape such as a polygonal shape. The outer peripheral surface of the shaft body 12 may be subjected to treatment, such as washing treatment, degreasing treatment, or primer treatment, for improving an adhesive property with an elastic layer 13.

The length of the shaft body 12 in its axial direction is not particularly limited, and may be appropriately adjusted in accordance with the form of the electrophotographic apparatus to be arranged. For example, when a printing target is A4 size, the length of the shaft body 12 in the axial direction is preferably 250 mm or more and 320 mm or less, more preferably 260 mm or more and 310 mm or less. In addition, the diameter (diameter of a circumscribed circle) of the shaft body 12 is also not particularly limited, and may be appropriately adjusted in accordance with the form of the electrophotographic apparatus to be arranged. For example, the outer diameter (diameter of the circumscribed circle) of the shaft body 12 is preferably 4 mm or more and 14 mm or less, more preferably 6 mm or more and 10 mm or less.

### [Elastic Layer]

The elastic layer 13 is formed by curing a rubber composition on the outer peripheral surface of the shaft body 12 through heating. The rubber composition for forming the elastic layer 13 preferably contains a rubber, an electroconductivity-imparting agent, and various additives as desired.

### (Rubber Composition)

### —Rubber—

Examples of the rubber in the rubber composition include a silicone rubber or a silicone-modified rubber, a nitrile rubber, an ethylene-propylene rubber (including an ethylene-propylene-diene rubber), a styrene-butadiene rubber, a butadiene rubber, an isoprene rubber, a natural rubber, an acrylic rubber, a chloroprene rubber, a butyl rubber, an epichlorohydrin rubber, a urethane rubber, and a fluororubber. The rubber in the rubber composition is preferably a silicone rubber or a silicone-modified rubber, or a urethane rubber. In addition, the rubber in the rubber composition is particularly preferably a silicone rubber or a silicone-modified rubber because the composition can be reduced in compression set and is excellent in flexibility under a low-temperature environment, and because the composition is excellent in, for example, heat resistance and charging characteristic. An example of the silicone rubber is a crosslinked product of an organopolysiloxane, such as dimethylpolysiloxane or diphenylpolysiloxane.

### —Electroconductivity-Imparting Agent—

The electroconductivity-imparting agent is preferably an electroconductive agent having an electron conductive mechanism, such as carbon black, graphite, copper, aluminum, nickel, iron powder, or an electroconductive metal oxide, an electroconductive agent having an ion conductive mechanism, such as an alkali metal salt or a quaternary ammonium salt, or an electroconductive agent containing an electroconductive composite particle having an electroconductive particle such as a carbon black particle applied to a surface of a silica particle.

The electroconductivity-imparting agent is particularly preferably carbon black. The carbon black is not particularly limited, and, for example, acetylene black, furnace black, channel black, ketjen black, or thermal black is suitably used. The carbon blacks may be used alone or in combination thereof. Two or more kinds of various electroconductive agents may be used in combination in order to obtain a desired electrical resistance.

The content of the electroconductivity-imparting agent in the rubber composition is preferably 0.5 mass % or more and 20 mass % or less, more preferably 1.0 mass % or more and 15 mass % or less, still more preferably 2.0 mass % or more and 10 mass % or less with respect to the whole amount of the rubber composition. When the content of the electroconductivity-imparting agent is adjusted within the above-mentioned ranges, the resistance value of a developing roller 11 is further stabilized, and printing performance is further improved. In addition, the compression set of the elastic layer 13 is reduced, and the durability of the developing roller 11 is further improved.

### —Various Additives—

The rubber composition may further contain various additives other than those described above. Examples of the various additives include an aid (e.g., a chain extender or a crosslinking agent), a catalyst, a dispersant, a foaming agent, an age inhibitor, an antioxidant, a filler, a pigment, a colorant, a processing aid, a softener, a plasticizer, an emulsifier, a heat resistance improver, a flame retardancy improver, an acid acceptor, a heat conductivity improver, a release agent, and a solvent.

Examples of a silicone rubber composition using the silicone rubber as the rubber in the rubber composition include an addition-curable millable electroconductive silicone rubber composition and an addition-curable liquid electroconductive silicone rubber composition.

The addition-curable millable electroconductive silicone rubber composition may be, for example, a composition containing (A) an organopolysiloxane represented by the following average composition formula (S1), (B) a filler, and (C) an electroconductivity-imparting agent.

R¹ₙSiO_{(4-n)/2} (S1)

In the formula (S1), “n” represents a positive number of 1.95 or more and 2.05 or less. In addition, R¹ represents a substituted or unsubstituted monovalent hydrocarbon group. The number of carbon atoms in the hydrocarbon group is preferably 1 or more and 12 or less, more preferably 1 or more and 8 or less. A plurality of R's in (A) the organopolysiloxane may be identical to each other, or part or all thereof may be different from each other.

R¹ represents, for example, any one of: alkyl groups, such as a methyl group, an ethyl group, a propyl group, a butyl group, a hexyl group, and a dodecyl group; cycloalkyl groups such as a cyclohexyl group; alkenyl groups, such as a vinyl group, an allyl group, a butenyl group, and a hexenyl group; aryl groups, such as a phenyl group and a tolyl group; and aralkyl groups such as a β-phenylpropyl group. In addition, R¹ may represent a group obtained by substituting part or all of hydrogen atoms in such hydrocarbon group with a substituent. The substituent may be, for example, a halogen atom or a cyano group. Examples of the hydrocarbon group having a substituent include a chloromethyl group, a trifluoropropyl group, and a cyanoethyl group.

A molecular chain terminal of (A) the organopolysiloxane is preferably blocked with: a trialkylsilyl group such as a trimethylsilyl group; a dialkylaralkylsilyl group such as a dimethylvinylsilyl group; a dialkylhydroxysilyl group such as a dimethylhydroxysilyl group; or a triaralkylsilyl group such as a trivinylsilyl group.
(A) The organopolysiloxane preferably has two or more alkenyl groups in a molecule thereof. (A) The organopolysiloxane preferably has 0.001 mol % or more and 5 mol % or less (more preferably 0.01 mol % or more and 0.5 mol % or less) of the alkenyl group out of R¹s. The alkenyl group of (A) the organopolysiloxane is particularly preferably a vinyl group.
(A) The organopolysiloxane may be obtained by, for example, subjecting one kind or two or more kinds of organohalosilanes to co-hydrolytic condensation, or subjecting a cyclic polysiloxane such as a trimer or tetramer of a siloxane to ring-opening polymerization. (A) The organopolysiloxane may be basically a linear diorganopolysiloxane, or may be partially branched. In addition, (A) the organopolysiloxane may be a mixture of two or more kinds thereof having different molecular structures.

The kinematic viscosity at 25° C. of (A) the organopolysiloxane is preferably 100 cSt or more, more preferably 100,000 cSt or more and 10,000,000 cSt or less. In addition, the polymerization degree of (A) the organopolysiloxane is preferably, for example, 100 or more, more preferably 3,000 or more and 10,000 or less.

An example of (B) the filler is a silica-based filler. Examples of the silica-based filler include fumed silica and precipitated silica.

A surface-treated silica-based filler subjected to surface treatment with a silane coupling agent represented by R²Si(OR³)₃ may be suitably used as the silica-based filler. Herein, R² may represent a group having a vinyl group or an amino group, and may represent, for example, a glycidyl group, a vinyl group, an aminopropyl group, a methacryloxy group, an N-phenylaminopropyl group, or a mercapto group. R³ may represent an alkyl group, and may represent, for example, a methyl group or an ethyl group.

The blending amount of the silica-based filler is preferably 11 parts by mass or more and 39 parts by mass or less, more preferably 15 parts by mass or more and 35 parts by mass or less with respect to 100 parts by mass of (A) the organopolysiloxane. In addition, the average particle diameter of the silica-based filler is preferably 1 μm or more and 80 μm or less, more preferably 2 μm or more and 40 μm or less. The average particle diameter of the silica-based filler may be measured as a median diameter through use of a particle size distribution measurement apparatus by a laser light diffraction method.

The blending amount of (C) the electroconductivity-imparting agent is preferably 0.5 part by mass or more, more preferably 1 part by mass or more with respect to 100 parts by mass of (A) the organopolysiloxane. In addition, the blending amount of (C) the electroconductivity-imparting agent is preferably 15 parts by mass or less, more preferably 10 parts by mass or less with respect to 100 parts by mass of (A) the organopolysiloxane.

The addition-curable millable electroconductive silicone rubber composition may further contain an additive other than (A) to (C). Examples of the additive include an aid (e.g., a chain extender or a crosslinking agent), a catalyst, a dispersant, a foaming agent, an age inhibitor, an antioxidant, a pigment, a colorant, a processing aid, a softener, a plasticizer, an emulsifier, a heat resistance improver, a flame retardancy improver, an acid acceptor, a heat conductivity improver, a release agent, and a solvent.

Specific examples of the additive include dispersants including a dimethylsiloxane oil having a polymerization degree lower than that of (A) the organopolysiloxane, a polyether-modified silicone oil, a silanol, both-terminal silanol group-capped lower-molecular-weight siloxanes, such as diphenylsilanediol and α,ω-dimethylsiloxanediol, and a silane. In addition, specific examples of the additive include heat resistance improvers, such as iron octylate, iron oxide, and cerium oxide. In addition, for example, various carbon functional silanes or various olefin-based elastomers for improving, for example, an adhesive property or molding processability may each be used as the additive.

The addition-curable liquid electroconductive silicone rubber composition may contain, for example, (D) an organopolysiloxane having two or more alkenyl groups in a molecule thereof, (E) an organohydrogen polysiloxane having two or more hydrogen atoms bonded to a silicon atom in a molecule thereof, (F) a filler, (G) an electroconductivity-imparting agent, and (H) an addition reaction catalyst. A compound represented by the following average composition formula (S2) is suitable as (D) the organopolysiloxane.

R⁴ₐ SiO₍₄₋ₐ₎₂ (S2)

In the formula (S2), “a” represents a positive number of 1.5 or more and 2.8 or less, preferably 1.8 or more and 2.5 or less, more preferably 1.95 or more and 2.05 or less. In addition, a plurality of R⁴s in (D) the organopolysiloxane may represent substituted or unsubstituted monovalent hydrocarbon groups, which are be identical to each other, or all or part of which may be different from each other. However, at least two of R⁴s in one molecule represent alkenyl groups. The number of carbon atoms in the hydrocarbon group is preferably 1 or more and 12 or less, more preferably 1 or more and 8 or less.

R⁴ may represent any one of the same groups as the groups given as the examples for R¹ described above. In addition, at least two of R⁴s in one molecule thereof represent alkenyl groups, and any other R⁴ preferably represents an alkyl group. The alkenyl group is preferably a vinyl group, and the alkyl group is preferably a methyl group. In addition, for example, 90% or more of R⁴s may each represent an alkyl group (preferably a methyl group).

The content of the alkenyl group in (D) the organopolysiloxane is preferably, for example, 1.0×10⁻⁶ mol/g or more and 5.0×10⁻³ mol/g or less, more preferably 5.0×10⁻⁶ mol/g or more and 1.0×10⁻³ mol/g or less.
(D) The organopolysiloxane is preferably liquid at 25° C., and has a viscosity at 25° C. of preferably 100 mPa·s or more and 1,000,000 mPa·s or less, more preferably 200 mPa·s or more and 100,000 mPa·s or less. In addition, the average polymerization degree of (D) the organopolysiloxane is preferably 100 or more and 800 or less, more preferably 150 or more and 600 or less.

A compound represented by the following average composition formula (S3) is suitable as (E) the organohydrogen polysiloxane.

R⁵_{b}H_{c}SiO_{(4-b-c)/2} (S3)

In the formula (S3), “b” represents a positive number of 0.7 or more and 2.1 or less, “c” represents a positive number of 0.001 or more and 1.0 or less, and b-c is 0.8 or more and 3.0 or less. In addition, a plurality of R⁵s in (E) the organohydrogen polysiloxane may represent substituted or unsubstituted monovalent hydrocarbon groups, which are identical to each other, or part or all of which may be different from each other. The number of carbon atoms in the hydrocarbon group is preferably 1 or more and 10 or less. R⁵ may represent any one of the same groups as the groups given as the examples for R¹ described above.
(E) The organohydrogen polysiloxane has two or more, preferably three or more hydrogen atoms bonded to a silicon atom (Si—H) in one molecule thereof. In addition, the number of hydrogen atoms bonded to a silicon atom in one molecule of (E) the organohydrogen polysiloxane is preferably 200 or less, more preferably 100 or less.

In (E) the organohydrogen polysiloxane, the content of the hydrogen atoms bonded to a silicon atom is preferably 0.001 mol/g or more and 0.017 mol/g or less, more preferably 0.002 mol/g or more and 0.015 mol/g or less.

Examples of (E) the organohydrogen polysiloxane include a both-terminal trimethylsiloxy group-blocked methyl hydrogen polysiloxane, a both-terminal trimethylsiloxy group-blocked dimethylsiloxane-methyl hydrogen siloxane copolymer, a both-terminal dimethyl hydrogen siloxy group-blocked dimethylpolysiloxane, a both-terminal dimethyl hydrogen siloxy group-blocked dimethylsiloxane-methyl hydrogen siloxane copolymer, a both-terminal trimethylsiloxy group-blocked methyl hydrogen siloxane-diphenylsiloxane copolymer, a both-terminal trimethylsiloxy group-blocked methyl hydrogen siloxane-diphenylsiloxane-dimethylsiloxane copolymer, a copolymer formed of a (CH₃)₂HSiO_{1/2} unit and a SiO_{4/2} unit, and a copolymer formed of a (CH₃)₂HSiO_{1/2} unit, a SiO_{4/2} unit, and a (C₆H₅)SiO_{3/2} unit.

The blending amount of (E) the organohydrogen polysiloxane is preferably 0.1 part by mass or more and 30 parts by mass or less, more preferably 0.3 part by mass or more and 20 parts by mass or less with respect to 100 parts by mass of (D) the organopolysiloxane. In addition, the molar ratio of Si—H of (E) the organohydrogen polysiloxane with respect to the alkenyl group of (D) the organopolysiloxane is preferably from 0.3 to 5.0, more preferably from 0.5 to 2.5.
(F) The filler may be, for example, a mineral filler. When (F) the filler is blended into the addition-curable liquid electroconductive silicone rubber composition, the compression set is reduced, the volume resistivity is stabilized over time, and sufficient roller durability is obtained.

The average particle diameter of (F) the filler is preferably 1 μm or more and 30 μm or less, more preferably 2 μm or more and 20 μm or less. When the average particle diameter of (F) the filler is 1 μm or more, a change in volume resistivity over time is further suppressed. In addition, when the average particle diameter of (F) the filler is 30 μm or less, the elastic layer 13 further excellent in durability can be obtained. The average particle diameter of (F) the filler may be measured as a median diameter through use of a particle size distribution measurement apparatus by a laser light diffraction method.

The bulk density of (F) the filler is preferably 0.1 g/cm³ or more and 0.5 g/cm³ or less, more preferably 0.15 g/cm³ or more and 0.45 g/cm³ or less. When the bulk density of (F) the filler is adjusted within the above-mentioned ranges, the compression set can be further reduced, the change in volume resistivity over time is further suppressed, and the elastic layer 13 further excellent in durability can be obtained. The bulk density of (F) the filler may be determined based on a method of measuring an apparent specific gravity of JIS K 6223.

Examples of (F) the filler include diatomaceous earth, perlite, mica, calcium carbonate, a glass flake, and a hollow filler. Of those, pulverized products of diatomaceous earth, perlite, and foamed perlite may each be suitably used as (F) the filler.

The blending amount of (F) the filler is preferably 5 parts by mass or more and 100 parts by mass or less, more preferably 10 parts by mass or more and 80 parts by mass or less with respect to 100 parts by mass of (D) the organopolysiloxane.

The blending amount of (G) the electroconductivity-imparting agent is preferably 0.5 part by mass or more and 15 parts by mass or less, more preferably 1 part by mass or more and 10 parts by mass or less with respect to 100 parts by mass of (D) the organopolysiloxane.
(H) The addition reaction catalyst only needs to be a catalyst that can activate an addition reaction of (D) the organopolysiloxane and (E) the organohydrogen polysiloxane. An example of (H) the addition reaction catalyst is a catalyst having a platinum group element. Examples of the catalyst having a platinum group element include a platinum-based catalyst (e.g., platinum black, platinic chloride, chloroplatinic acid, or a reaction product of chloroplatinic acid and a monohydric alcohol, a complex of chloroplatinic acid and an olefin, or platinum bisacetoacetate), a palladium-based catalyst, and a rhodium-based catalyst.

The blending amount of (H) the addition reaction catalyst may be a catalytic amount. For example, the blending amount of (H) the addition reaction catalyst is preferably such an amount that the amount of the platinum group element becomes 0.5 ppm by mass or more and 1,000 ppm by mass or less with respect to the total mass of (D) the organopolysiloxane and (E) the organohydrogen polysiloxane. In addition, the blending amount of (H) the addition reaction catalyst is more preferably such an amount that the amount of the platinum group element becomes 1 ppm by mass or more and 500 ppm by mass or less with respect to the total mass of (D) the organopolysiloxane and (E) the organohydrogen polysiloxane.

The addition-curable liquid electroconductive silicone rubber composition may further contain an additive other than (D) to (H). Examples of the additive include an aid (e.g., a chain extender or a crosslinking agent), a foaming agent, a dispersant, an age inhibitor, an antioxidant, a pigment, a colorant, a processing aid, a softener, a plasticizer, an emulsifier, a heat resistance improver, a flame retardancy improver, an acid acceptor, a heat conductivity improver, a release agent, a diluent, a reactive diluent, and a solvent.

Specific examples of the additive include dispersants, such as a lower-molecular-weight siloxane ester, a polyether-modified silicone oil, a silanol, and phenylsilanediol. The examples also include heat resistance improvers, such as iron octylate, iron oxide, and cerium oxide. In addition, various carbon functional silanes or various olefin-based elastomers for improving, for example, an adhesive property or molding processability may be used. In addition, a halogen compound or the like for imparting flame retardancy may be used.

The viscosity at 25° C. of the addition-curable liquid electroconductive silicone rubber composition is preferably 5 Pa·s or more and 500 Pa·s or less, more preferably 5 Pa·s or more and 200 Pa·s or less.

The elastic layer 13 is formed on the outer peripheral surface of the shaft body 12 by simultaneously or consecutively performing the curing by heating and the molding by a known molding method. A method of curing the rubber composition only needs to be a method that can apply heat required for curing of a rubber composition, and a method of molding the elastic layer 13 is not particularly limited, and is, for example, consecutive vulcanization by extrusion molding, pressing, or die molding by injection. For example, when the rubber composition is the addition-curable millable electroconductive silicone rubber composition, for example, extrusion molding may be selected, and when the rubber composition is the addition-curable liquid electroconductive silicone rubber composition, for example, a molding method using a die may be selected.

The heating temperature at the time of the curing of the rubber composition is, in the case of the addition-curable millable electroconductive silicone rubber composition, preferably 100° C. or more and 500° C. or less, particularly preferably 120° C. or more and 300° C. or less, and the heating time thereof is several seconds or more and 1 hour or less, particularly preferably 10 seconds or more and 35 minutes or less. In the case of the addition-curable liquid electroconductive silicone rubber composition, the heating time thereof is preferably 100° C. or more and 300° C. or less, particularly preferably 110° C. or more and 200° C. or less, and the heating time thereof is 5 minutes or more and 5 hours or less, particularly preferably 1 hour or more and 3 hours or less. In addition, secondary vulcanization may be performed as required. In the case of the addition-curable millable electroconductive silicone rubber composition, curing conditions of, for example, 100° C. or more and 200° C. or less for about 1 hour or more and about 20 hours or less are selected. In addition, in the case of the addition-curable liquid electroconductive silicone rubber composition, curing conditions of, for example, 120° C. or more and 250° C. or less for about 2 hours or more and about 70 hours or less are selected.

In addition, the sponge-shaped elastic layer 13 having air bubbles may be easily formed by foaming and curing the rubber composition by a known method. The thickness of the elastic layer 13 is not particularly limited, and is preferably 0.1 mm or more and 6 mm or less, more preferably 1 mm or more and 4 mm or less. The term “thickness” herein refers to a thickness in a direction perpendicular to the axial direction of the developing roller 11. The outer diameter of the elastic layer 13 is not particularly limited, and is preferably, for example, 6 mm or more and 25 mm or less. The outer peripheral surface of the elastic layer 13 may be subjected to surface treatment, such as primer treatment, corona treatment, plasma treatment, excimer treatment, UV treatment, ITRO treatment, or flame treatment, for the purpose of, for example, improving an adhesive property with a coating layer 14. A method of forming the elastic layer 13 is not particularly limited. For example, the elastic layer 13 may be formed by a method, such as extrusion molding or LIMS molding of the silicone rubber composition. In addition, the elastic layer 13 may be formed by, for example, grinding or polishing of an elastic body (cured product of the silicone rubber composition) formed on the shaft body 12.

### [Coating Layer]

The coating layer 14 is the outer periphery of the elastic layer 13 and is arranged on the outermost surface of the developing roller. The coating layer 14 preferably contains a second binder resin, and a silica particle dispersed in the second binder resin. The coating layer 14 is formed by: applying a resin composition to the outer peripheral surface of the elastic layer 13 or a primer layer formed as desired; and then curing the applied resin composition by heating. The resin composition contains at least a urethane preparation component for forming a urethane resin as the second binder resin, and a silica particle.

In the formation of the coating layer 14, the formation is not necessarily required to be performed by curing the resin composition by heating, and the coating layer may be a layer formed by silicone coating treatment using ethyl silicate, or treatment involving incorporating, for example, a titanium-based, aluminum-based, or zirconium-based material into a treatment agent thereof. The application of the resin composition is performed by, for example, a known application method, such as a coating method of applying, for example, an application liquid of the resin composition, a dipping method of immersing, for example, the elastic layer 13 in the application liquid, or a spray coating method of spraying the application liquid on the elastic layer 13. The resin composition may be applied as it is, or an application liquid obtained by adding, for example, a volatile solvent including an alcohol, such as methanol or ethanol, an aromatic solvent, such as xylene or toluene, or an ester-based solvent, such as ethyl acetate or butyl acetate, or water to the resin composition may be applied.

A method of curing the resin composition applied in this manner only needs to be a method that can impart heat or moisture required for, for example, curing of the resin composition. For example, examples of the method of curing the resin composition include a method of heating, for example, the elastic layer 13 to which the resin composition is applied with a heater, and a method of leaving, for example, the elastic layer 13 to which the resin composition is applied at rest under high humidity. The heating temperature when the resin composition is cured by heating is preferably, for example, 100° C. or more and 200° C. or less, and in particular, more preferably 120° C. or more and 160° C. or less. In addition, the heating time is preferably 10 minutes or more and 120 minutes or less, more preferably 30 minutes or more and 60 minutes or less. A method involving, while or after laminating the resin composition on the outer peripheral surface of the elastic layer 13 or the primer layer by a known molding method, such as extrusion molding, press molding, or injection molding, curing the laminated resin composition may be adopted instead of the application.

In the coating layer 14 formed in this manner, a precursor for forming the resin, the electroconductivity-imparting agent to be described later, or the like may be integrated by a reaction or may form a composite, or the electroconductivity-imparting agent may be dispersed in the resin without a reaction with the precursor for forming the resin.

### (Slip Angle)

A slip angle of the surface of the developing roller used in the present invention is preferably 10° or more and 40° or less. The surface of the developing roller means a surface of the coating layer 14. Herein, the term “slip angle” means an angle formed between a base and a horizontal surface obtained in the following condition when the developing roller starts to slip to one end portion side. First, the base on which a polyethylene terephthalate (PET) film is laid is arranged horizontally (angle with the horizontal surface:) 0°, and the developing roller is arranged on the base so that the longitudinal direction of the base and the axial direction of the developing roller are parallel to each other. Next, under a state in which one end portion of the base in the longitudinal direction is fixed, the base is gradually inclined by raising the other end portion.

When the slip angle of the surface of the developing roller is 10° or more, the developing roller can satisfactorily carry a developer to convey the developer to the photosensitive member. In addition, when the slip angle is 40° or less, the developer adheres to the developing roller and then easily desorbs, and hence a predetermined amount of the developer in accordance with image data can be supplied. That is, when the slip angle is set to 10° or more and 40° or less, the developer can be appropriately carried and conveyed, and hence a high-quality image can be maintained.

### (Thickness)

The thickness of the coating layer 14 is preferably 1 μm or more and 20 μm or less. When the thickness of the coating layer 14 is adjusted within the above-mentioned ranges, printing durability performance can be improved while filming is satisfactorily suppressed.

Components to be incorporated into the coating layer 14 are described below.

### (Urethane Resin)

The coating layer 14 contains a urethane resin as the second binder resin. Any urethane preparation component serving as a precursor for forming the urethane resin may be adopted as long as an urethane resin can be formed, and an example thereof is a mixture of a polyol and an isocyanate. The polyol only needs to be any of various polyols typically used for the preparation of polyurethane, and is preferably at least one kind of polyol selected from polyether polyol, polyester polyol, polyacrylate polyol, and polycarbonate polyol.

Examples of the polyether polyol include: polyalkylene glycols, such as polyethylene glycol, polypropylene glycol, and polypropylene glycol-ethylene glycol; polytetramethylene ether glycol; a copolymerized polyol of tetrahydrofuran and an alkylene oxide; and various modified forms thereof or mixtures thereof.

The polyester polyol has two or more ester bonds and two or more hydroxyl groups in a molecule thereof. An example of the polyester polyol include a condensation reaction product of a dicarboxylic acid and a polyol. Examples of the dicarboxylic acid include: aromatic dicarboxylic acids, such as phthalic acid, terephthalic acid, and isophthalic acid; and aliphatic dicarboxylic acids, such as adipic acid and sebacic acid.

The polyacrylate polyol is a copolymer of a hydroxyl group-containing monomer and any other olefin-based unsaturated monomer, such as an ester of (meth) acrylic acid, styrene, α-methylstyrene, vinyltoluene, a vinyl ester, a maleic acid monoalkyl ester and a maleic acid dialkyl ester, a fumaric acid monoalkyl ester and a fumaric acid dialkyl ester, an α-olefin, and any other unsaturated oligomer and unsaturated polymer. The expression “(meth) acrylic acid” herein means a compound of acrylic acid or methacrylic acid. In other words, for example, the term “(meth) acrylic acid ester” means an acrylic acid ester or a methacrylic acid ester.

The polycarbonate polyol has two or more carbonate bonds and two or more hydroxyl groups in a molecule thereof. An example of the polycarbonate polyol is a condensation reaction product of a polyol and a carbonate compound. In addition, examples of the carbonate compound include a dialkyl carbonate, a diaryl carbonate, and an alkylene carbonate. Examples of the polyol to be used for a raw material of the polycarbonate polyol include: diols, such as hexanediol and butanediol; and triols such as 2,4-butanetriol.

The isocyanate only needs to be any of various isocyanates typically used for the preparation of polyurethane, and examples thereof include an aliphatic isocyanate, an aromatic isocyanate, and derivatives thereof. The isocyanate is preferably an aliphatic isocyanate because of excellent storage stability and ease of control of a reaction rate.

Examples of the aromatic isocyanate include xylylene diisocyanate (XDI), diphenylmethane diisocyanate (MDI), toluene diisocyanate (sometimes referred to as “tolylene diisocyanate,” TDI), 3,3′-bitolylene-4,4′-diisocyanate, 3,3′-dimethyldiphenylmethane-4,4′-diisocyanate, 2,4-tolylene diisocyanate urethidine dione (dimer of 2,4-TDI), xylene diisocyanate, naphthalene diisocyanate (NDI), p-phenylene diisocyanate (PDI), tolidine diisocyanate (TODI), and m-phenylene diisocyanate.

Examples of the aliphatic isocyanate include hexamethylene diisocyanate (HDI), 4,4′-dicyclohexylmethane diisocyanate (hydrogenated MDI), o-toluidine diisocyanate, lysine diisocyanate methyl ester, isophorone diisocyanate (IPDI), norbornane diisocyanate methyl ester, trans-cyclohexane-1,4-diisocyanate, and triphenylmethane-4,4′,4″-triisocyanate.

Examples of the derivative include a polynuclear product of polyisocyanate, a urethane-modified product (including a urethane prepolymer) thereof modified with, for example, a polyol, a dimer thereof formed by formation of urethdione, and an isocyanurate-modified product, a carbodiimide-modified product, a urethonimine-modified product, an allophanate-modified product, a urea-modified product, and a biuret-modified product thereof.

The polyisocyanates may be used alone or in combination thereof. The polyisocyanate preferably has a molecular weight of from 500 to 2,000, more preferably has a molecular weight of from 700 to 1,500.

A mixing ratio in a mixture of the polyol and the polyisocyanate is not particularly limited. Typically, a molar ratio (NCO/OH) between the hydroxy group (OH) in the polyol and the isocyanate group (NCO) in the polyisocyanate is preferably 0.7 or more and 1.15 or less. The molar ratio (NCO/OH) is more preferably 0.85 or more and 1.10 or less because hydrolysis of polyurethane can be prevented. In actuality, an amount corresponding to three times to four times as high as a proper molar ratio may be blended in consideration of an operation environment and an operational error.

In the urethane preparation component, an aid typically used for the reaction between the polyol and the polyisocyanate, such as a chain extender or a crosslinking agent, may be used in combination in addition to the polyol and the polyisocyanate. Examples of the chain extender and the crosslinking agent include glycols, hexanetriol, trimethylolpropane, and amines.

### (Silica Particle)

The coating layer 14 of the developing roller 11 used in the present invention contains a silica particle. In addition, the silica particle may be subjected to surface treatment, such as hydrophobization or hydrophilization, as required. The silica particles may be used alone or in combination thereof. The average particle diameter (median diameter (d50)) of the silica particle is preferably 10 nm or more and 5 μm or less from the viewpoint that the developer is satisfactorily carried.

The content of the silica particle is preferably 1 part by mass or more and 10 parts by mass or less with respect to 100 parts by mass of the urethane preparation component in the resin composition for forming the coating layer 14. When the content is set to 1 part by mass or more, the slipperiness of the surface of the coating layer 14 is improved, and the developer can be satisfactorily carried to be conveyed to the photosensitive member. In addition, when the content is set to 10 parts by mass or less, dispersion of the particle can be improved, and hence uniformity of the surface state of the coating layer 14 can be kept. Accordingly, filming can be satisfactorily suppressed. The content of the silica particle is more preferably 2 parts by mass or more and 8 parts by mass or less with respect to 100 parts by mass of the urethane preparation component.

### (Electroconductivity-Imparting Agent)

The coating layer 14 may further contain an electroconductivity-imparting agent. The electroconductivity-imparting agent is not particularly limited as long as the electroconductivity-imparting agent is a component that can impart electroconductivity to the coating layer 14. The electroconductivity-imparting agent to be used for the elastic layer 13 may be used as the electroconductivity-imparting agent. The blending amount of the electroconductivity-imparting agent is not particularly limited, and may be appropriately adjusted in accordance with, for example, the kind or desired electroconductivity of the electroconductivity-imparting agent. In addition, the electroconductivity-imparting agents may be used alone or in combination thereof.

### (Other Component)

The coating layer 14 may further contain an additive other than the above-mentioned additives. For example, the coating layer 14 may further contain an additive, such as a silane coupling agent, a lubricant, a polymerization catalyst, a dispersant, or a filler.

The coating layer 14 may be formed by applying a resin composition for forming a coating layer onto the elastic layer 13 and polymerizing the polyol component and the isocyanate component with each other by heating or the like. The solvent to be used for the coating liquid is preferably a solvent that can dissolve a polyol component and a polyisocyanate component, and may be, for example, ethyl acetate or butyl acetate.

### (Hydroxy Group-Containing Ion Liquid Free of Ether Group)

The urethane resin composition for forming the coating layer 14 preferably contains a hydroxy group-containing ion liquid free of an ether group. The “ion liquid” is one kind of onium salt formed of a cation and an anion, and is a liquid compound having high electroconductivity in a liquid state at a temperature around at least room temperature, and is also referred to as “ionic liquid.” The ion liquid in the present invention has a role of an ion electroconductive agent that imparts electroconductivity to the coating layer 14. When the ion liquid is used, a residual potential caused by printing for a long time period can be reduced. Accordingly, filming can be satisfactorily suppressed.

The ion liquid used in the present invention does not include an ether group in a molecule thereof, has at least one hydroxy group, and preferably has at least one hydroxy group at a terminal thereof. Such ion liquid is preferably an aliphatic amine-based ion liquid having an ammonium ion as a cation, a pyridinium-based ion liquid having a pyridinium ion as a cation, or an imidazolium-based ion liquid having an imidazolium ion as a cation. The ion liquids to be incorporated into the urethane resin composition may be used alone or in combination thereof.

When the ion liquid has a hydroxy group, the ion liquid reacts with an isocyanate serving as a material of the urethane resin, and hence an unreacted ion liquid can be prevented from bleeding out. In addition, when the ion liquid does not include an ether group, a water content in the urethane resin composition can be reduced, and hence contamination of the image bearing member, the blade, and the supply roller caused by an uncured urethane resin composition can be prevented, and hence a horizontal streak and a vertical streak on a printed image can be prevented.

The content of (c) a hydroxy group-containing ion liquid free of an ether group in the urethane resin composition is preferably 0.1 part by mass or more and 10 parts by mass or less when the total content of (a) a polyacrylic polyol and (b) a polyisocyanate is set to 100 parts by mass. In addition, the content of (c) the hydroxy group-containing ion liquid free of an ether group in the coating layer 14 is preferably 0.1 part by mass or more and 10 parts by mass or less when the content of the second binder resin is set to 100 parts by mass. When the content of the ion liquid is set to 0.1 part by mass or more with respect to 100 parts by mass of the second binder resin, preferred electroconductivity can be secured in the developing roller. When the content of the ion liquid is set to 10 parts by mass or less with respect to 100 parts by mass of the second binder resin, in the case where the number of hydroxy groups in the ion liquid is two or more, the crosslinking density does not become excessive. Accordingly, abrasion or deterioration of the toner on an outermost surface layer coat caused by repeated printing can be suppressed, and hence the image quality in the initial stage can be maintained.

### (Crosslinked (Meth) Acrylic Acid Ester Resin Particle)

The coating layer 14 preferably contains at least one resin particle selected from the group consisting of: a crosslinked acrylic acid ester resin particle; and a crosslinked methacrylic acid ester resin particle. The crosslinked (meth) acrylic acid ester is used for forming unevenness on the surface of the coating layer 14. The crosslinked (meth) acrylic acid ester is a resin particle obtained by crosslinking of the (meth)acrylic acid ester. Examples of the acrylic acid ester include methyl acrylate, butyl acrylate, 2-ethylhexyl acrylate, methyl methacrylate, butyl methacrylate, hexyl methacrylate, and a urethane (meth) acrylic acid ester.

The crosslinked (meth) acrylic acid ester resin particle particularly preferably has a recovery rate of 20% or more and a 10% compressive strength of 0.1 MPa or more and 2.2 MPa or less. From such viewpoints, of the above-mentioned acrylic acid esters, a urethane (meth) acrylic acid ester is particularly preferred. It is preferred that the crosslinked (meth) acrylic acid ester resin particle have a recovery rate of 20% or more and a 10% compressive strength of 0.1 MPa or more and 2.2 MPa or less.

Herein, the term “recovery rate (%)” in the present invention means a value determined as described below. First, after a load of 9.8 mN is applied, a displacement (displacement of the particle diameter) amount when the load is reduced to 0.98 mN is measured. Subsequently, a recovery rate (%) is determined by the following mathematical formula 1 from the measured displacement amount of the particle diameter and a particle diameter of a spherical particle before the load is applied.

$$Recovery rate ( \% ) = [ displacement amount ( μm ) of particle diameter / particle diameter ( μm ) ] \times 100 \qquad ( Mathematical Formula 1 )$$

### (Measurement Conditions for Recovery Rate)

Test temperature: 50% RH at 23° C.
Upper pressure indenter: diamond plane indenter having a diameter of 50 μm
Lower pressure plate: SKS flat plate
Measurement mode: unloading test
Loading rate: 0.98 mN/sec
Maximum load: 9.8 mN

In addition, the “10% compressive strength” in the present invention means a value measured by the following method. A value measured with a microcompression testing machine MCT manufactured by Shimadzu Corporation under the following measurement conditions is adopted. When a test force is applied to one spherical particle at a loading rate of 0.98 mN/sec, a test force at the time point when the displacement amount reaches 10% of the particle diameter is defined as a compressive strength (MPa).

### (Measurement Conditions for Compressive Strength)

Test temperature: 50% RH at 23° C.
Upper pressure indenter: diamond plane indenter having a diameter of 50 μm
Lower pressure plate: SKS flat plate
Measurement mode: compression test
Loading rate: 0.98 mN/sec
Maximum load: until 10% of the particle diameter is reached

As a commercially available product of the crosslinked (meth) acrylic acid ester resin particle having a recovery rate of 20% or more and a 10% compressive strength of 0.1 MPa or more and 2.2 MPa or less, there is given, for example, TECHPOLYMER AFX-8 (manufactured by Sekisui Plastics Co., Ltd.).

The average particle diameter of the crosslinked (meth) acrylic acid ester resin particle is not particularly limited, and when the average particle diameter becomes excessively larger than the thickness of the coating layer 14, the surface unevenness of the coating layer 14 becomes large, and a toner particle is liable to remain on a recess of the surface. Meanwhile, when the average particle diameter becomes excessively small, a protrusion is not formed on the coating layer 14, and hence charging performance of the coating layer 14 may become unstable. Accordingly, the average particle diameter of the crosslinked (meth) acrylic acid ester resin particle is preferably made equal to the thickness of the coating layer 14 from the viewpoint of suppressing the remaining of the toner particle on the coating layer 14 while stabilizing the charging performance of the developing roller. Specifically, the average particle diameter of the at least one resin particle selected from the group consisting of: the crosslinked acrylic acid ester resin particle; and the crosslinked methacrylic acid ester resin particle is preferably 1 μm or more and 15 μm or less. The average particle diameter of the crosslinked (meth) acrylic acid ester resin particle is more preferably 2 μm or more and 10 μm or less.

The average particle diameter of the crosslinked (meth) acrylic acid ester resin particle is set to a value obtained by the following method of measuring the volume-average diameter of resin particles.

### [Method of Measuring Volume-Average Diameter of Resin Particles]

Measurement of the volume-average diameter of the resin particles (arithmetic average diameter in a volume-based particle size distribution) is performed with Coulter Multisizer II (measurement apparatus manufactured by Beckman Coulter, Inc.) by the following method. In this measurement, measurement is performed by calibration with a 50 μm aperture in accordance with Reference MANUAL FOR THE COULTER MULTISIZER (1987) published by Coulter Electronics Limited.

Specifically, 0.1 g of the resin particles are preliminarily dispersed in 10 ml of a 0.1 wt % nonionic surfactant to provide a dispersion liquid. In this case, a touch mixer (“TOUCHMIXER MT-31” manufactured by Yamato Scientific Co., Ltd.) and an ultrasonic washing machine (“ULTRASONIC CLEANER VS-150” manufactured by VELVO-CLEAR) are used for the preliminary dispersion.

Next, a beaker filled with ISOTON (trademark) II (manufactured by Beckman Coulter, Inc., electrolyte for measurement) attached to a main body of Coulter Multisizer II is prepared. The dispersion liquid is dropped into the beaker with a dropper while being lightly stirred, and the reading of a concentration meter on a screen of the main body of Coulter Multisizer II is adjusted to around 10%.

Next, an aperture size (diameter) of 50 μm, a current (aperture electrode) of 800 μA, a gain of 4, a polarity (polarity of inner electrode) of “+” were input to the main body of Coulter Multisizer II to perform measurement in a manual mode. During the measurement, an inside of the beaker is lightly stirred to the extent that no air bubbles enter, and the measurement is completed at the time point when the measurement of 100,000 resin particles is completed.

An arithmetic average diameter of the volume-based particle size distribution of the 100,000 resin particles is defined as a volume-average diameter.

The content of the crosslinked (meth) acrylic acid ester resin particle is not particularly limited, and as the content becomes larger, plastic deformation of the coating layer 14 can be further suppressed. However, when the content increases, the density of a crosslinked acrylic resin particle distributed in the coating layer 14 increases, and hence the surface unevenness of the coating layer 14 may become large. In this case, the toner particle is liable to remain on the surface of the coating layer 14, and hence the charging performance of the developing roller decreases. Accordingly, the content of the crosslinked (meth) acrylic acid ester resin particle is preferably 5 parts by mass or more and 50 parts by mass or less with respect to 100 parts by mass of the urethane preparation component from the viewpoint of achieving an appropriate surface roughness so that the toner particle does not remain while the plastic deformation of the coating layer 14 is suppressed. The content is more preferably 8 parts by mass or more and 40 parts by mass or less with respect to 100 parts by mass of the urethane preparation component.

### [Other Configuration]

The developing roller 11 used in the present invention may include an intermediate layer, such as an adhesion layer or the primer layer, between the shaft body 12 and the elastic layer 13, or between the elastic layer 13 and the coating layer 14. Herein, the electrical characteristics of the adhesion layer and the primer layer, which are arranged between the elastic layer 13 and the coating layer 14, out of those intermediate layers can be adjusted to adjust the electrical characteristics as the developing roller 11. As a result, the development performance of the developing roller 11 as a developing roller can be satisfactorily adjusted. A primer layer typically used as a primer layer of the developing roller may be used as the primer layer, and the development performance of the developing roller can be satisfactorily maintained by, for example, forming a primer layer formed of a urethane resin having an ester group.

### [Electrophotographic Apparatus]

An embodiment of the electrophotographic apparatus according to the present invention is described below in detail.

An electrophotographic apparatus according to the present invention includes the electrophotographic photosensitive member described in the foregoing, a charging unit, an exposing unit, and a developing unit. The charging unit is configured to charge the surface of the electrophotographic photosensitive member. In addition, the exposing unit is configured to irradiate the surface of the charged electrophotographic photosensitive member with light to form an electrostatic latent image on the surface of the electrophotographic photosensitive member. In addition, the developing unit includes toner, and is configured to develop the electrostatic latent image formed on the surface of the electrophotographic photosensitive member with the toner to form a toner image on the surface of the electrophotographic photosensitive member. Further, the developing unit is the developing roller described in the foregoing.

A tandem-type color electrophotographic apparatus is described below as an example with reference to FIG. 5. FIG. 5 is a sectional view for illustrating an example of an electrophotographic apparatus. An electrophotographic apparatus 100 illustrated in FIG. 5 includes image forming units 40a, 40b, 40c, and 40d, a transfer belt 50, and a fixing device 54. When distinction is not required, each of the image forming units 40a, 40b, 40c, and 40d is hereinafter referred to as “image forming unit 40.” The image forming unit 40 includes an image bearing member 30, a charging device 42 as a charging unit, an exposing device 44 as an exposing unit, a developing device 46 as a developing unit, and a transfer device 48 as a transfer unit. The image bearing member 30 is a photosensitive member (specifically, the monolayer type photosensitive member 1). In addition, a recording medium P is located in a lower portion of the electrophotographic apparatus. The image bearing member 30 is arranged at the center position of the imaging forming unit 40. The image bearing member 30 is arranged so as to be rotatable in the arrow direction (counterclockwise direction in FIG. 5). The charging device 42, the exposing device 44, the developing device 46, and the transfer device 48 are arranged on the periphery of the image bearing member 30 in the stated order from an upstream side in the rotation direction of the image bearing member 30.

Toner images of a plurality of colors (e.g., four colors of black, cyan, magenta, and yellow) are successively superimposed on the recording medium P on the transfer belt 50 by each of the image forming units 40a to 40d.

The charging device 42 charges the surface (e.g., a peripheral surface) of the image bearing member 30 with positive polarity. When the image bearing member 30 is the monolayer type photosensitive member 1, the surface of the image bearing member 30 is charged with positive polarity. The charging device 42 is, for example, a charging roller.

The exposing device 44 irradiates the charged surface of the image bearing member 30 with exposure light. That is, the exposing device 44 exposes the charged surface of the image bearing member 30 to light. As a result, an electrostatic latent image is formed on the surface of the image bearing member 30. The electrostatic latent image is formed based on image data input to the electrophotographic apparatus 100. The developing device 46 supplies toner to the surface of the image bearing member 30, to thereby develop the electrostatic latent image as a toner image. The developing device 46 (e.g., the surface of the developing device 46, more specifically, the peripheral surface of the developing device 46) is in contact with the surface of the image bearing member 30. That is, the electrophotographic apparatus 100 adopts a contact developing system. The developing device 46 is, for example, a developing roller. When a developer is a one-component developer, the developing device 46 supplies toner that is a one-component developer to the electrostatic latent image formed on the image bearing member 30. When the developer is a two-component developer, the developing device 46 supplies toner among the toner and a carrier in the two-component developer to the electrostatic latent image formed on the image bearing member 30. In this manner, the image bearing member 30 bears the toner image.

The transfer belt 50 conveys the recording medium P to the position between the image bearing member 30 and the transfer device 48. The transfer belt 50 is an endless belt. The transfer belt 50 is arranged so as to be rotatable in the arrow direction (clockwise direction in FIG. 5). The transfer device 48 transfers the toner image developed by the developing device 46 from the surface of the image bearing member 30 to a transfer target member. The transfer target member is the recording medium P. When the toner image is transferred, the image bearing member 30 is in contact with the recording medium P. That is, the electrophotographic apparatus 100 adopts a direct transfer system. The transfer device 48 is, for example, a transfer roller. The recording medium P having the toner image transferred thereto by the transfer device 48 is conveyed to the fixing device 54 by the transfer belt 50.

An example of the electrophotographic apparatus has been described above, but the electrophotographic apparatus is not limited to the electrophotographic apparatus 100 described above. The electrophotographic apparatus 100 described above is a color electrophotographic apparatus, but the electrophotographic apparatus may also be a monochrome electrophotographic apparatus. In this case, it is only required that the electrophotographic apparatus include, for example, only one image forming unit.

In addition, the electrophotographic apparatus 100 described above adopts a tandem system, but the electrophotographic apparatus may also adopt, for example, a rotary system.

The charging device 42 has been described by taking the charging roller as an example, but the charging device may be a charging device other than the charging roller (e.g., a scorotron charger, a charging brush, or a corotron charger). The electrophotographic apparatus 100 described above adopts a contact developing system, but the electrophotographic apparatus may also adopt a non-contact developing system.

The electrophotographic apparatus 100 described above adopts a direct transfer system, but the electrophotographic apparatus may also adopt an intermediate transfer system. When the electrophotographic apparatus adopts an intermediate transfer system, the transfer target member corresponds to an intermediate transfer belt. In the electrophotographic apparatus, the image forming unit 40 described above does not include a cleaning member, but the image forming unit may further include a cleaning member (e.g., a cleaning blade).

The image forming unit 40 described above does not include a charge eliminating device, but the image forming unit may further include a charge eliminating device.

### [Process Cartridge]

Next, with continued reference to FIG. 5, an example of a process cartridge that can be used in the present invention is described. The process cartridge corresponds to each of the image forming units 40a to 40d. The process cartridge includes the image bearing member 30. The image bearing member 30 is a photosensitive member of a first embodiment. The process cartridge further includes, in addition to the image bearing member 30, at least one selected from the group consisting of: the charging device 42; the exposing device 44, the developing device 46; and the transfer device 48. The process cartridge can further include the cleaning member and the charge eliminating device.

The process cartridge is designed so as to be detachably attachable onto the electrophotographic apparatus 100. Thus, the process cartridge is easy to handle and can be easily and quickly replaced together with the image bearing member 30 when the sensitivity characteristic and the like of the image bearing member 30 deteriorate. The process cartridge including the photosensitive member has been described above with reference to FIG. 5.

According to the present invention, the excellent electrophotographic apparatus in which a decrease in transfer efficiency and toner scattering after endurance can be suppressed, and high image quality is maintained from an initial stage to a stage after endurance in the electrophotographic apparatus using a developing roller for suppressing filming is provided.

### EXAMPLES

The present invention is described below in more detail by way of Examples and Comparative Examples. The present invention is by no means limited by the following Examples within a scope not departing from the gist of the present invention. In the following description of Examples, the term “part(s)” is by mass unless otherwise specified.

### <Production of Polyester Resin>

### [Synthesis of Resin (PAR-1)]

A three-necked flask including a temperature gauge, a three-way cock, and a dropping funnel was used as a reaction vessel.

The following materials were prepared.

| | | |
|---|---|---|
| Compound (BP-2) serving as a monomer: | 41.0 | mmol |
| 2,6-Dimethylphenol (DMP) serving as | 0.213 | mmol |
| an end terminator: | | |
| Sodium hydroxide: | 98 | mmol |
| Benzyltributylammonium chloride: | 0.384 | mmol |

Those materials were loaded into the reaction vessel, and air in the reaction vessel was replaced by an argon gas. 300 Milliliters of water was added to the contents of the reaction vessel. The contents of the reaction vessel were stirred at 50° C. for 1 hour. The contents of the reaction vessel were cooled to 10° C. to provide an alkaline aqueous solution A1.

Next, 32.0 mmol of a dicarboxylic acid dichloride of the compound (DC-1) serving as a monomer was dissolved in 150 mL of chloroform. As a result, a chloroform solution B1 was obtained.

The chloroform solution B1 was slowly dropped into the alkaline aqueous solution A1 over 110 minutes through use of the dropping funnel. The contents of the reaction vessel were stirred for 4 hours to allow a polymerization reaction to proceed while the temperature (liquid temperature) of the contents of the reaction vessel was regulated to 15±5° C. The upper layer (aqueous layer) of the contents of the reaction vessel was removed by decantation. Thus, an organic layer was obtained. Next, 400 mL of ion-exchanged water was loaded into an Erlenmeyer flask. The resultant organic layer was further added to the Erlenmeyer flask. 400 Milliliters of chloroform and 2 mL of acetic acid were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation. Thus, an organic layer was obtained. The resultant organic layer was washed with ion-exchanged water (1 L) through use of a separating funnel. The washing with ion-exchanged water was repeated five times. Thus, a water-washed organic layer was obtained. Next, the water-washed organic layer was filtered to provide filtrate. The resultant filtrate was slowly dropped into 1 L of methanol to provide a precipitate. The precipitate was taken out by filtration. The precipitate thus taken out was dried in a vacuum at a temperature of 70° C. for 12 hours. As a result, a resin (PAR-1) having a viscosity-average molecular weight of 35,000 was obtained.

### [Synthesis of Resin (PAR-2)]

A three-necked flask including a temperature gauge, a three-way cock, and a dropping funnel was used as a reaction vessel.

The following materials were prepared.

| | | |
|---|---|---|
| Compound (BP-5) serving as a monomer | 28.7 | mmol |
| Compound (BP-2) serving as a monomer | 12.3 | mmol |
| 2,6-Dimethylphenol (DMP) serving as | 0.413 | mmol |
| an end terminator | | |
| Sodium hydroxide | 98 | mmol |
| Benzyltributylammonium chloride | 0.384 | mmol |

Those materials were loaded into the reaction vessel, and air in the reaction vessel was replaced by an argon gas. 300 Milliliters of water was added to the contents of the reaction vessel. The contents of the reaction vessel were stirred at 50° C. for 1 hour. The contents of the reaction vessel were cooled to 10° C. to provide an alkaline aqueous solution A2.

Next, 20.8 mmol of a dicarboxylic acid dichloride of the compound (DC-1) serving as a monomer, and 11.2 mmol of a dicarboxylic acid dichloride of the compound (DC-4) serving as a monomer were dissolved in 150 mL of chloroform. As a result, a chloroform solution B2 was obtained.

The chloroform solution B2 was slowly dropped into the alkaline aqueous solution A2 over 110 minutes through use of the dropping funnel. The contents of the reaction vessel were stirred for 4 hours to allow a polymerization reaction to proceed while the temperature (liquid temperature) of the contents of the reaction vessel was regulated to 15±5° C. The upper layer (aqueous layer) of the contents of the reaction vessel was removed by decantation. Thus, an organic layer was obtained. Next, 400 mL of ion-exchanged water was loaded into an Erlenmeyer flask. The resultant organic layer was further added to the Erlenmeyer flask. 400 Milliliters of chloroform and 2 mL of acetic acid were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation. Thus, an organic layer was obtained. The resultant organic layer was washed with 1 L of ion-exchanged water through use of a separating funnel. The washing with ion-exchanged water was repeated five times. Thus, a water-washed organic layer was obtained. Next, the water-washed organic layer was filtered to provide filtrate. The resultant filtrate was slowly dropped into 1 L of methanol to provide a precipitate. The precipitate was taken out by filtration. The precipitate thus taken out was dried in a vacuum at a temperature of 70° C. for 12 hours. As a result, a resin (PAR-2) having a viscosity-average molecular weight of 55,000 was obtained.

### [Synthesis of Resins (PAR-3 to PAR-15)]

Synthesis was performed by the same method as that in the synthesis of the resin (PAR-2) except that a relative ratio between the bisphenol and the dicarboxylic acid and the kind and usage amount of the end terminator were changed. Thus, polyester resins having viscosity-average molecular weights shown in Table 1 were obtained. As the loading amount of the end terminator becomes smaller, the viscosity-average molecular weight of each of the polyester resins becomes higher.

TABLE 1

| | | | Dicarboxylic | | | |
|---|---|---|---|---|---|---|
| | Bisphenol | | acid | | End | Molecular |
| Resin | BP-2 | BP-5 | DC-1 | DC-4 | terminator | weight |
| PAR-1 | 100 | — | 100 | — | DMP | 35,000 |
| PAR-2 | 70 | 30 | 65 | 35 | DMP | 55,000 |
| PAR-3 | 70 | 30 | 50 | 50 | DMP | 53,100 |
| PAR-4 | 70 | 30 | 55 | 45 | DMP | 66,000 |
| PAR-5 | 50 | 50 | 65 | 35 | DMP | 79,000 |
| PAR-6 | 50 | 50 | 50 | 50 | DMP | 61,000 |
| PAR-7 | 50 | 50 | 55 | 45 | DMP | 51,000 |
| PAR-8 | 20 | 80 | 65 | 35 | DMP | 56,000 |
| PAR-9 | 20 | 80 | 70 | 30 | DMP | 54,000 |
| PAR-10 | 20 | 80 | 30 | 70 | DMP | 53,000 |
| PAR-11 | 20 | 80 | 55 | 45 | DMP | 67,000 |
| PAR-12 | 20 | 80 | 55 | 45 | PFH | 53,000 |
| PAR-13 | — | 100 | 50 | 50 | DMP | 55,000 |
| PAR-14 | 50 | 50 | — | 100 | DMP | 60,000 |
| PAR-15 | — | 100 | — | 100 | DMP | 68,000 |

The numerical values described for the bisphenols in Table 1 each represent a molar ratio of each bisphenol monomer to the total substance amount in terms of mole of two kinds of bisphenols. In addition, the numerical values described for the dicarboxylic acids each represent a molar ratio of each dicarboxylic acid monomer to the total substance amount in terms of mole of two kinds of dicarboxylic acids. In addition, “PFH” represents 1H,1H-perfluoro-1-heptanol. In addition, the molecular weight indicates a viscosity-average molecular weight.

### <Production of Electrophotographic Photosensitive Member>

### [Production of Photosensitive Member 1]

The following materials were prepared.

| | | |
|---|---|---|
| Y-form titanyl phthalocyanine (CGM-1) | 2.0 | parts by mass |
| serving as a charge generating material | | |
| Hole transporting material (H-11) | 70.0 | parts by mass |
| Electron transporting material (E-4) | 50.0 | parts by mass |
| Resin (PAR-1) serving as a binder resin | 100.0 | parts by mass |
| Tetrahydrofuran serving as a solvent | 500.0 | parts by mass |

Those materials were mixed with a rod-shaped sonic oscillator for 20 minutes to provide a dispersion liquid. The dispersion liquid was filtered through a filter having an opening of 5 μm to provide a coating liquid for a photosensitive layer. The coating liquid for a photosensitive layer was applied onto an electroconductive base (drum-shaped support made of aluminum) by a dip coating method, and was dried with hot air at 120° C. for 50 minutes. In this manner, a photosensitive layer (thickness: 30 μm) was formed on the electroconductive base to provide a photosensitive member 1.

### (Resin Component Analysis of Photosensitive Member 1)

A ¹H-NMR spectrum was obtained by ¹H-nuclear magnetic resonance spectrometry of polymer components recovered from the resultant photosensitive member 1 in deuterated chloroform. The resultant ¹H-NMR spectrum had peaks at 8.22±0.02 ppm, 7.18±0.02 ppm, 7.16±0.02 ppm, 7.10±0.02 ppm, 7.06±0.02 ppm, and 7.04±0.02 ppm. As a result, it was specified that the photosensitive member 1 had the respective structural units represented by the formula (1) and the formula (2). In addition, a ratio between the substance amounts in terms of mole of the respective structural units represented by the formula (1) and the formula (2) was 1:1 as shown in Table 1 based on the integration ratios of the above-mentioned peaks.

### [Production of Photosensitive Members 2 to 24]

Photosensitive members 2 to 24 were each produced by the same method as that in the production of the photosensitive member 1 except that the kind of each of the charge generating material (CGM), the additive, the hole transporting material (HTM), the electron transporting material (ETM), and the binder resin was changed. The kinds of the charge generating material, the additive, the hole transporting material, the electron transporting material, and the binder resin used are shown in Table 2. The usage amount of each of the materials is the same as that in production of the photosensitive member 1.

### (Resin Component Analysis of Photosensitive Members 2 to 24)

A ¹H-NMR spectrum was obtained by ¹H-nuclear magnetic resonance spectrometry of polymer components recovered from the resultant photosensitive members 2 to 24 in deuterated chloroform. The resultant 1H-NMR spectrum had peaks at 8.22±0.02 ppm, 7.18±0.02 ppm, 7.16±0.02 ppm, 7.10±0.02 ppm, 7.06±0.02 ppm, 7.04±0.02 ppm, 2.28±0.02 ppm, 2.20±0.02 ppm, 1.59±0.02 ppm, and 1.54±0.02 ppm. As a result, it was specified that the photosensitive members 2 to 24 had each of the structural units represented by the formula (1), the formula (2), the formula (4), and the formula (5). In addition, the ratios between the substance amount in terms of mole of each of the structural units represented by the formula (1), the formula (2), the formula (4), and the formula (5) were as shown in Table 1 based on the integration ratios of the above-mentioned peaks.

TABLE 2

| Photosensitive member | Resin | CGM | HTM | ETM | Additive |
|---|---|---|---|---|---|
| Photosensitive member-1 | PAR-1 | CGM-1 | H-11 | E-4 | T-1 |
| Photosensitive member-2 | PAR-2 | CGM-1 | H-11 | E-4 | T-1 |
| Photosensitive member-3 | PAR-3 | CGM-1 | H-11 | E-4 | T-1 |
| Photosensitive member-4 | PAR-4 | CGM-1 | H-11 | E-4 | T-1 |
| Photosensitive member-5 | PAR-5 | CGM-1 | H-11 | E-4 | T-1 |
| Photosensitive member-6 | PAR-6 | CGM-1 | H-11 | E-4 | T-1 |
| Photosensitive member-7 | PAR-7 | CGM-1 | H-11 | E-4 | T-1 |
| Photosensitive member-8 | PAR-8 | CGM-1 | H-11 | E-4 | T-1 |
| Photosensitive member-9 | PAR-9 | CGM-1 | H-11 | E-4 | T-1 |
| Photosensitive member-10 | PAR-10 | CGM-1 | H-11 | E-4 | T-1 |
| Photosensitive member-11 | PAR-11 | CGM-1 | H-11 | E-4 | T-1 |
| Photosensitive member-12 | PAR-12 | CGM-1 | H-11 | E-4 | T-1 |
| Photosensitive member-13 | PAR-8 | CGM-1 | H-11 | E-4 | — |
| Photosensitive member-14 | PAR-8 | CGM-1 | H-1 | E-4 | T-1 |
| Photosensitive member-15 | PAR-8 | CGM-1 | H-5 | E-4 | T-1 |
| Photosensitive member-16 | PAR-8 | CGM-1 | H-9 | E-4 | T-1 |
| Photosensitive member-17 | PAR-8 | CGM-1 | H-10 | E-4 | T-1 |
| Photosensitive member-18 | PAR-8 | CGM-1 | H-11 | E-1 | T-1 |
| Photosensitive member-19 | PAR-8 | CGM-1 | H-11 | E-2 | T-1 |
| Photosensitive member-20 | PAR-8 | CGM-1 | H-11 | E-7 | T-1 |
| Photosensitive member-21 | PAR-8 | CGM-1 | H-11 | E-8 | T-1 |
| Photosensitive member-22 | PAR-13 | CGM-1 | H-11 | E-4 | T-1 |
| Photosensitive member-23 | PAR-14 | CGM-1 | H-11 | E-4 | T-1 |
| Photosensitive member-24 | PAR-15 | CGM-1 | H-11 | E-4 | T-1 |

### <Method of Preparing Developing Roller>

### [Production of Developing Roller A]

A shaft body (made of SUM22, diameter: 10 mm, length: 275 mm) subjected to electroless nickel plating treatment was washed with ethanol, and a silicone-based primer (product name: “Primer No. 16”, manufactured by Shin-Etsu Chemical Co., Ltd.) was applied to a surface thereof. The shaft body having subjected to primer treatment was subjected to firing treatment with a Geer oven at a temperature of 150° C. for 10 minutes, and then cooled at normal temperature for 30 minutes or more to form a primer layer on the outer peripheral surface of the shaft body.

Next, a silicone rubber composition for forming an elastic layer was prepared as described below. First, the following materials were prepared.

| | | |
|---|---|---|
| Dimethylpolysiloxane blocked with | 100 | parts by mass |
| dimethylvinylsiloxy groups at both terminals | | |
| thereof (polymerization degree: 300) | | |
| Fumed silica (product name: “R-972”, | 1 | part by mass |
| manufactured by Nippon Aerosil Co., Ltd.) | | |
| subjected to hydrophobization treatment, the | | |
| fumed silica having a BET specific surface | | |
| area of 110 m²/g | | |
| Diatomaceous earth (product name: “Oplight | 40 | parts by mass |
| W-3005S”, manufactured by Chuo Silika Co., | | |
| Ltd.) having an average particle diameter of | | |
| 6 μm and a bulk density of 0.25 g/cm³ | 5 | parts by mass |
| Acetylene black (product name: “DENKA | | |
| BLACK HS-100”, manufactured by Denka | | |
| Company Limited) | | |

Those materials were loaded into a planetary mixer, stirred for 30 minutes, and then passed through a triple roll once. The resultant was returned again to the planetary mixer. Subsequently, the following materials were prepared.

| | | |
|---|---|---|
| Methyl hydrogen polysiloxane having Si—H | 2.1 | parts by mass |
| groups at both terminals thereof and on side | | |
| chains thereof (polymerization degree: 17, | | |
| Si—H amount: 0.0060 mol/g) | | |
| Ethynyl cyclohexanol | 0.1 | part by mass |
| Platinum catalyst (Pt concentration: 1%) | 0.1 | part by mass |

Those materials were added to the planetary mixer, and were subjected to stirring to defoaming and kneading for 30 minutes. Thus, an addition-curable liquid electroconductive silicone rubber composition was prepared. The prepared addition-curable liquid electroconductive silicone rubber composition was subjected to injection molding using a die to mold an elastic body formed of a rubber material on the outer peripheral surface of the shaft body. In the injection molding, the addition-curable liquid electroconductive silicone rubber composition was cured by heating at 120° C. for 10 minutes, and the resultant was subjected to secondary vulcanization at 200° C. for 4 hours to mold an elastic layer having an outer diameter of 16 mm.

Next, a resin composition for forming a coating layer was prepared as described below.

First, the following materials were prepared.

| | | |
|---|---|---|
| Acrylic polyol | 35 | parts by mass |
| Hexamethylene diisocyanate (product name: | 46 | parts by mass |
| “DURANATE E402-B80B”, manufactured | | |
| by Asahi Kasei Corporation) | | |
| Dibutyltin dilaurate (manufactured by | 0.03 | part by mass |
| Tokyo Chemical Industry Co., Ltd.) | | |
| Small-diameter silica (average particle diameter: | 4 | parts by mass |
| 4.4 μm, product name: “ACEMATT OK-607”, | | |
| manufactured by Evonik Degussa) | | |
| Carbon black (product name: “DENKA | 3 | parts by mass |
| BLACK HS-100”, manufactured by | | |
| Denka Company Limited) serving as an | | |
| electroconductivity-imparting agent | | |
| Thinner | 30 | parts by mass |

Those materials were mixed to provide a urethane resin composition.

Subsequently, the urethane resin composition was applied to the outer peripheral surface of the elastic layer by a spray coating method. The composition was heated at 160° C. for 30 minutes to form a coating layer having a thickness of 12 μm. In this manner, a developing roller A including a shaft body, an elastic layer, and a coating layer was produced.

### [Production of Developing Roller B]

A developing roller B was produced in the same manner as the developing roller A except that a coating layer was formed with the following resin composition.

First, the following materials were prepared.

| | |
|---|---|
| Acrylic polyol | 42 parts by mass |
| Hexamethylene diisocyanate (product name: “DURANATE E402-B80B”, manufactured | 52 parts by mass |
| by Asahi Kasei Corporation) | |
| Dibutyltin dilaurate (manufactured by Tokyo Chemical Industry Co., Ltd.) | 0.03 part by mass |
| Small-diameter silica (average particle diameter: 4.4 μm, product name: “ACEMATT | 4 parts by mass |
| OK-607”, manufactured by Evonik Degussa) | |
| Carbon black (product name: “DENKA BLACK HS-100”, manufactured by Denka | 3 parts by mass |
| Company Limited) | |
| Pyridinium-based ion liquid {N-hydroxyethylpyridinium | 0.7 part by mass |
| bis(trifluorometasulfonyl)imide} (see the following structural formula) | |
| 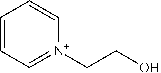 | |
| 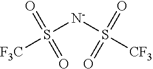 [SMILES: O=S(=O)([N-]S(=O)(=O)C(F)(F)F)C(F)(F)F] | |
| Thinner | 30 parts by mass |

Those materials were mixed to provide a urethane resin composition.

Subsequently, the urethane resin composition was applied to the outer peripheral surface of the elastic layer by a spray coating method. The composition was heated at 160° C. for 30 minutes to form a coating layer having a thickness of 15 μm. In this manner, a developing roller B including a shaft body, an elastic layer, and a coating layer was produced.

### [Production of Developing Roller C]

A developing roller C was produced in the same manner as the developing roller A except that a coating layer was formed with the following resin composition.

First, the following materials were prepared.

| | | |
|---|---|---|
| Acrylic polyol | 42 | parts by mass |
| Hexamethylene diisocyanate (product name: | 52 | parts by mass |
| “DURANATE E402-B80B”, manufactured | | |
| by Asahi Kasei Corporation) | | |
| Dibutyltin dilaurate (manufactured by | 0.03 | part by mass |
| Tokyo Chemical Industry Co., Ltd.) | | |
| Small-diameter silica (average particle diameter: | 4 | parts by mass |
| 4.4 μm, product name: “ACEMATT OK-607”, | | |
| manufactured by Evonik Degussa) | | |
| Crosslinked acrylic acid ester resin particle | 10 | parts by mass |
| having a recovery rate of 20%, a 10% | | |
| compressive strength of 0.4 MPa, and an | | |
| average particle diameter of 8 μm (product | | |
| name: “TECHPOLYMER AFX-8”, | | |
| manufactured by Sekisui Plastics Co., Ltd.) | | |
| Carbon black (product name: “DENKA | 3 | parts by mass |
| BLACK HS-100”, manufactured by | | |
| Denka Company Limited) | | |
| Pyridinium-based ion liquid | 0.7 | part by mass |
| {N-hydroxyethylpyridinium | | |
| bis(trifluorometasulfonyl)imide} (see the | | |
| above-mentioned structural formula) | | |
| Thinner | 30 | parts by mass |

Those materials were mixed to provide a resin composition.

Subsequently, the urethane resin composition was applied to the outer peripheral surface of the elastic layer by a spray coating method. The composition was heated at 160° C. for 30 minutes to form a coating layer having a thickness of 15 μm. In this manner, a developing roller C including a shaft body, an elastic layer, and a coating layer was produced.

### [Production of Developing Roller D]

A developing roller D was produced in the same manner as the developing roller A except that a coating layer was formed with the following resin composition.

First, the following materials were prepared.

| | | |
|---|---|---|
| Acrylic polyol | 42 | parts by mass |
| Hexamethylene diisocyanate (product name: | 52 | parts by mass |
| “DURANATE E402-B80B”, manufactured | | |
| by Asahi Kasei Corporation) | | |
| Dibutyltin dilaurate (manufactured by | 0.03 | part by mass |
| Tokyo Chemical Industry Co., Ltd.) | | |
| Carbon black (product name: “DENKA | 3 | parts by mass |
| BLACK HS-100”, manufactured by | | |
| Denka Company Limited) | | |
| Thinner | 30 | parts by mass |

Those materials were mixed to provide a urethane resin composition.

Subsequently, the urethane resin composition was applied to the outer peripheral surface of the elastic layer by a spray coating method. The composition was heated at 160° C. for 30 minutes to form a coating layer having a thickness of 13 μm. In this manner, a developing roller D including a shaft body, an elastic layer, and a coating layer was produced.

### [Evaluation]

Filming resistance, scattering, and transfer efficiency were evaluated by a method to be described below through use of each of the photosensitive members (monolayer type photosensitive members) and each of the developing rollers produced as described above.

A reconstructed machine of a monochrome laser printer HL-5200 manufactured by Brother Industries, Ltd. was used as an electrophotographic apparatus. A high-voltage power supply control system (product name: Model 615-3, manufactured by TREK, Inc.) was used as a power supply for supplying power for a corona charger from the outside of the printer. An electrophotographic photosensitive member in a drum unit in a cartridge for the printer was removed, and each of the produced photosensitive members was set instead. In addition, each of the produced developing rollers was also set to the electrophotographic apparatus. The toner of the developing unit of the electrophotographic apparatus was set to positively charged toner.

### <Evaluation of Filming Resistance>

The developer adhering to the surface of the developing roller after the printing was performed on 10,000 sheets with the electrophotographic apparatus mounted with the produced developing roller under the conditions of a temperature 23° C. and a humidity of 55% RH was sucked, and then a mass of the developer transferred to a filming weight measuring jig was measured. With regard to the filming evaluation, the mass of the transferred developer was evaluated by the following criteria. In this test, the filming amount was determined to be acceptable when the evaluation was C or higher.
A: The mass of the transferred developer is 0 mg or more and less than 0.02 mg.
B: The mass of the transferred developer is 0.02 mg or more and less than 0.04 mg.
C: The mass of the transferred developer is 0.04 mg or more and less than 0.06 mg.
D: The mass of the transferred developer is 0.06 mg or more.

### <Toner Scattering Evaluation>

The evaluation of toner scattering was performed under a normal-temperature and high-humidity environment (temperature: 25.0° C., relative humidity: 80%). As an evaluation image, an image of a horizontal line pattern obtained by printing horizontal lines of 4 dots at intervals of 176 dot space was output on A4 size OceRedLabel paper (basis weight: 80 g/m²) manufactured by Canon Inc. An image output test was performed on a total of 1,000 sheets according to, as a printing mode, a mode set so that the printing on 2 sheets was defined as one job, and the machine was stopped once between a job and a next job before the next job started. Thus, toner scattering evaluation was performed. The evaluation was performed by observation of an image on a 1,000th sheet through use of a loupe at a magnification of 25.

Criteria of scattering are shown below. When the scattering evaluation is C or higher, the scattering was judged to be satisfactory.
A: No toner scattering occurred when observation was performed with a loupe at a magnification of 25.
B: Toner scattering occurred at several sites around the image when observation was performed with a loupe at a magnification of 25.
C: A large amount of toner scattering occurred around the image when observation was performed with a loupe at a magnification of 25.
D: Occurrence of toner scattering was even visually recognized, though being below the level regarded as a problem in practical use.
E: Occurrence of toner scattering was clearly visually recognized.

### <Transfer Efficiency>

A density of a portion bonded onto paper in the case of attaching a transfer residual portion on the photosensitive member with a chart that can form a plurality of images of 1 cm×20 cm strips was represented by D1, and a density of a portion in the case of attaching after being transferred onto paper was represented by D2. Thus, the transfer efficiency was calculated by using the following formula.

$$Transfer efficiency ( \% ) = \{ D 2 / ( D 1 + D 2 ) \} \times 100$$

A difference in transfer efficiency between an initial stage and after 15,000 sheets were passed under a low-temperature and low-humidity environment (L/L; 10° C./14% RH) was evaluated by the following criteria.
A: The difference was less than 2% and was satisfactory.
B: The difference was 2% or more and less than 4% and there was no problem in practical use.
C: The difference was 4% or more and less than 6% and there was no problem in practical use.
D: The difference was 6% or more and less than 8% and there was a problem in practical use.
E: The difference was 8% or more and there was a problem in practical use.

The evaluation results are shown in Table 3.

TABLE 3

| | | | Filming | Transfer | |
|---|---|---|---|---|---|
| | Photosensitive member | Developing roller | evaluation | efficiency | Scattering |
| Example 1 | Photosensitive member 1 | Developing roller C | A | C | C |
| Example 2 | Photosensitive member 2 | Developing roller C | A | C | B |
| Example 3 | Photosensitive member 3 | Developing roller C | A | C | C |
| Example 4 | Photosensitive member 4 | Developing roller C | A | B | C |
| Example 5 | Photosensitive member 5 | Developing roller C | A | B | C |
| Example 6 | Photosensitive member 6 | Developing roller C | A | C | B |
| Example 7 | Photosensitive member 7 | Developing roller C | A | B | B |
| Example 8 | Photosensitive member 8 | Developing roller C | A | B | B |
| Example 9 | Photosensitive member 9 | Developing roller C | A | B | B |
| Example 10 | Photosensitive member 10 | Developing roller C | A | B | B |
| Example 11 | Photosensitive member 11 | Developing roller C | A | B | B |
| Example 12 | Photosensitive member 12 | Developing roller C | A | B | B |
| Example 13 | Photosensitive member 13 | Developing roller C | A | C | B |
| Example 14 | Photosensitive member 14 | Developing roller A | C | B | A |
| Example 15 | Photosensitive member 14 | Developing roller B | B | B | A |
| Example 16 | Photosensitive member 14 | Developing roller C | A | A | A |
| Example 17 | Photosensitive member 15 | Developing roller C | A | A | A |
| Example 18 | Photosensitive member 16 | Developing roller C | A | A | A |
| Example 19 | Photosensitive member 17 | Developing roller C | A | B | B |
| Example 20 | Photosensitive member 18 | Developing roller C | A | B | B |
| Example 21 | Photosensitive member 19 | Developing roller C | A | B | B |
| Example 22 | Photosensitive member 20 | Developing roller C | A | A | B |
| Example 23 | Photosensitive member 21 | Developing roller C | A | A | B |
| Comparative | Photosensitive member 22 | Developing roller C | A | E | D |
| Example 1 | | | | | |
| Comparative | Photosensitive member 23 | Developing roller C | A | D | E |
| Example 2 | | | | | |
| Comparative | Photosensitive member 24 | Developing roller C | A | C | E |
| Example 3 | | | | | |
| Comparative | Photosensitive member 14 | Developing roller D | D | A | A |
| Example 4 | | | | | |

In Examples 1 to 22 using the photosensitive member containing a polyester resin and the developing roller each used in the present invention, filming was suppressed, and the quality of an output image was maintained at an initial stage and through repeated use. Meanwhile, in Comparative Examples, there was a result that both of the filming property and the suppression of a failure at the time of transfer were not achieved through repeated use.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-010285, filed Jan. 26, 2024, and Japanese Patent Application No. 2024-222370, filed Dec. 18, 2024, which are hereby incorporated by reference herein in their entirety.

What is claimed is:

1. An electrophotographic apparatus comprising:
an electrophotographic photosensitive member;
a charging unit configured to charge a surface of the electrophotographic photosensitive member;
an exposing unit configured to irradiate the charged surface of the electrophotographic photosensitive member with light to form an electrostatic latent image on the surface of the electrophotographic photosensitive member; and
a developing unit, which includes toner, and which is configured to develop the electrostatic latent image formed on the surface of the electrophotographic photosensitive member with the toner to form a toner image on the surface of the electrophotographic photosensitive member,
wherein the electrophotographic photosensitive member includes a monolayer type photosensitive layer containing a charge generating material, a hole transporting material, an electron transporting material, and a first binder resin,
wherein the photosensitive layer contains, as the first binder resin, a polyester resin having a structural unit represented by the following formula (1) and a structural unit represented by the following formula (2): 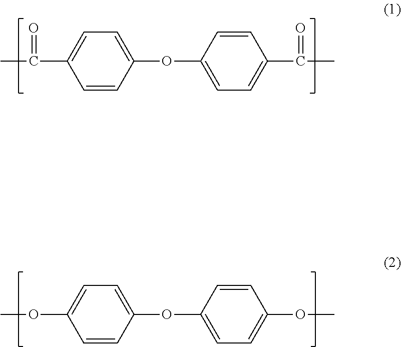
wherein the developing unit is a developing roller including a shaft body, an elastic layer arranged on an outer periphery of the shaft body, and a coating layer arranged on an outer periphery of the elastic layer, and
wherein the coating layer contains a second binder resin and a silica particle.

2. The electrophotographic apparatus according to claim 1, wherein the polyester resin further has a structural unit represented by the following formula (4) and a structural unit represented by the following formula (5).

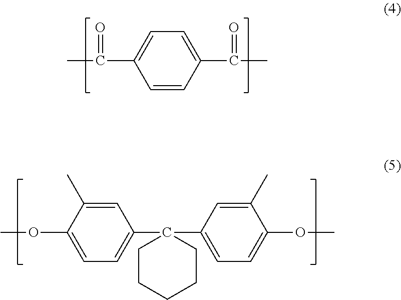

3. The electrophotographic apparatus according to claim 2, wherein, in the polyester resin, when a ratio of a substance amount in terms of mole of the structural unit represented by the formula (1) with respect to a sum of substance amounts in terms of mole of the structural units constituting the polyester resin is represented by M1 and a ratio of a substance amount in terms of mole of the structural unit represented by the formula (4) with respect to the sum of substance amounts in terms of mole of the structural units constituting the polyester resin is represented by M4, M4/(M1+M4) is 0.30 or more and 0.70 or less.

4. The electrophotographic apparatus according to claim 2, wherein, in the polyester resin, when a ratio of a substance amount in terms of mole of the structural unit represented by the formula (2) with respect to a sum of substance amounts in terms of mole of the structural units constituting the polyester resin is represented by M2 and a ratio of a substance amount in terms of mole of the structural unit represented by the formula (5) with respect to the sum of substance amounts in terms of mole of the structural units constituting the polyester resin is represented by M5, M2/(M2+M5) is 0 or more and 0.50 or less.

5. The electrophotographic apparatus according to claim 1, wherein, when a sum of substance amounts in terms of mole of structural units derived from dicarboxylic acids, the structural units constituting the polyester resin is represented by MC and a substance amount in terms of mole of the structural unit represented by the formula (1) constituting the polyester resin is represented by M1, M1/MC is 0.50 or more.

6. The electrophotographic apparatus according to claim 1, wherein a content ratio of the polyester resin is 50 mass % or more with respect to a total mass of the first binder resin.

7. The electrophotographic apparatus according to claim 1, wherein the electron transporting material contains at least any one compound selected from the group consisting of: a compound represented by the following formula (10); a compound represented by the following formula (11); a compound represented by the following formula (12); a compound represented by the following formula (13); a compound represented by the following formula (14); a compound represented by the following formula (15); and a compound represented by the following formula (16): 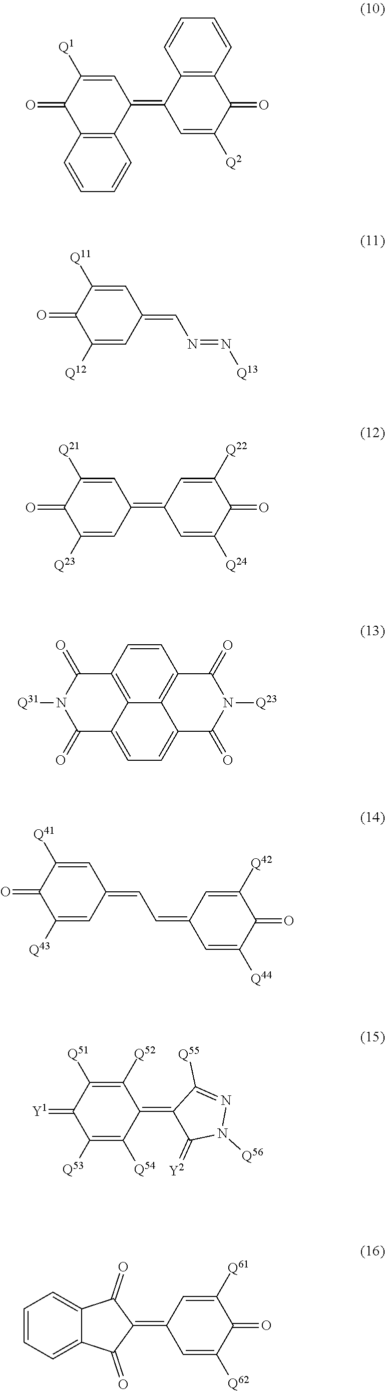
where Q¹ and Q² in the formula (10), Q¹¹, Q¹², and Q¹³ in the formula (11), Q²¹, Q²², Q²³, and Q²⁴ in the formula (12), Q³¹ and Q³² in the formula (13), Q⁴¹, Q⁴², Q⁴³, and Q⁴⁴ in the formula (14), Q⁵¹, Q⁵², Q⁵³, Q⁵⁴, Q⁵⁵, and Q⁵⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least any one substituent selected from the group consisting of: an alkyl group having 1 or more and 6 or less carbon atoms; and a halogen atom, and Y¹ and Y² in the formula (15) each independently represent an oxygen atom or a sulfur atom.

8. The electrophotographic apparatus according to claim 7, wherein the electron transporting material contains at least any one compound selected from the group consisting of: a compound represented by the following formula (E-1); a compound represented by the following formula (E-2); a compound represented by the following formula (E-3); a compound represented by the following formula (E-4); a compound represented by the following formula (E-5); a compound represented by the following formula (E-6); a compound represented by the following formula (E-7); and a compound represented by the following formula (E-8).

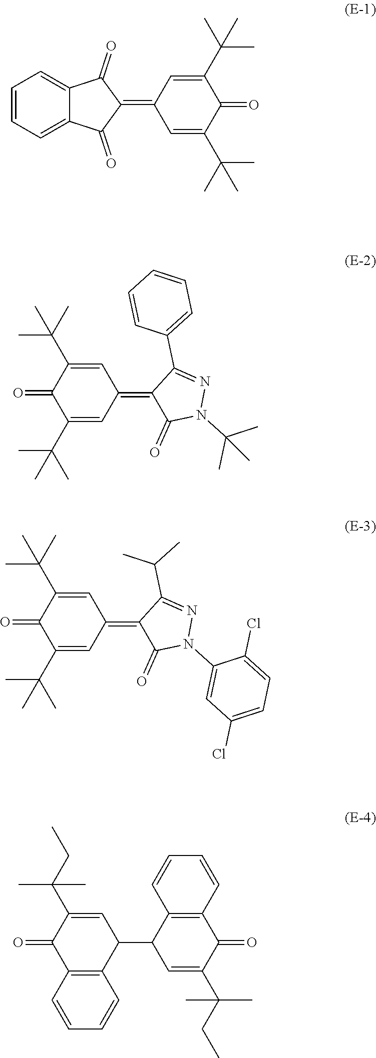 [SMILES: CC(C)(C)C1=CC(=C2C(=O)c3ccccc3C2=O)C=C(C(C)(C)C)C1=O ; CC(C)(C)C1=CC(=C2C(=O)N(C(C)(C)C)N=C2c2ccccc2)C=C(C(C)(C)C)C1=O ; CC(C)C1=NN(c2cc(Cl)ccc2Cl)C(=O)C1=C1C=C(C(C)(C)C)C(=O)C(C(C)(C)C)=C1 ; CCC(C)(C)C1=CC(C2C=C(C(C)(C)CC)C(=O)c3ccccc32)c2ccccc2C1=O]

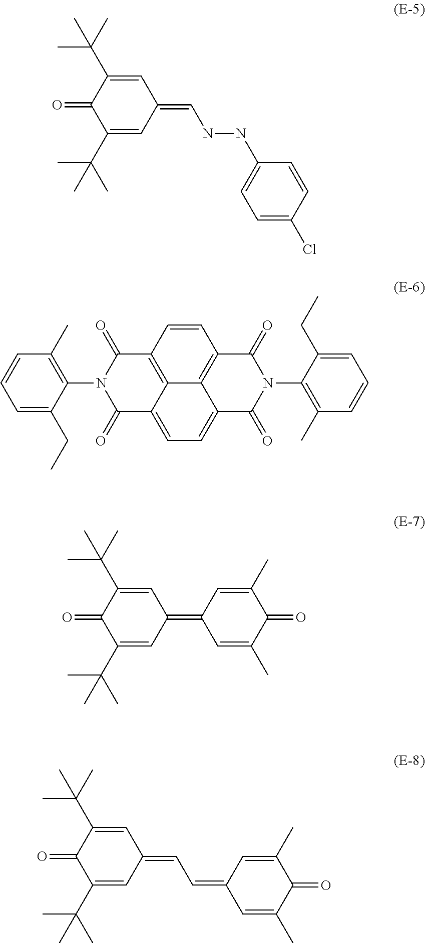 [SMILES: CC(C)(C)C1=CC(=CNNc2ccc(Cl)cc2)C=C(C(C)(C)C)C1=O ; CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

9. The electrophotographic apparatus according to claim 1, wherein the hole transporting material contains at least any one compound selected from the group consisting of: a compound represented by the following formula (20); a compound represented by the following formula (21); a compound represented by the following formula (22); a compound represented by the following formula (23); and a compound represented by the following formula (24): 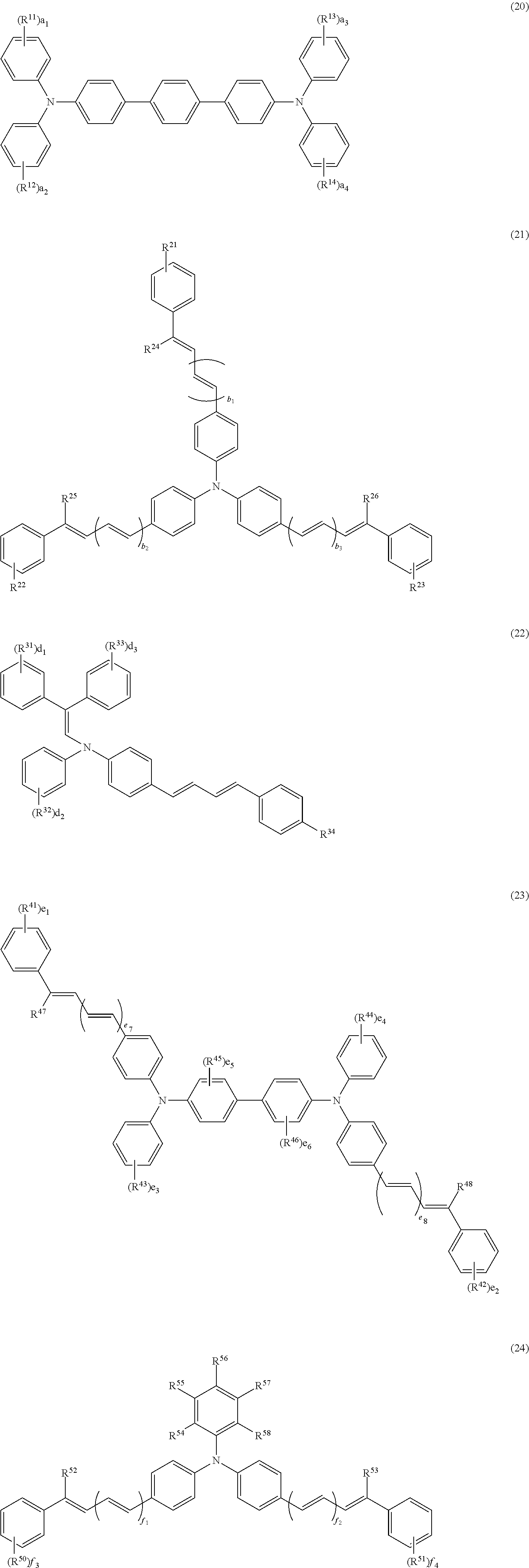
in the formula (20), R¹¹, R¹², R¹³, and R¹⁴ each independently represent an alkyl group having 1 or more and 6 or less carbon atoms, or an alkoxy group having 1 or more and 6 or less carbon atoms, and a¹, a², a³, and a⁴ each independently represent an integer of 0 or more and 5 or less; in the formula (21), R²¹, R²², and R²³ each independently represent an alkyl group having 1 or more and 6 or less carbon atoms, R²⁴, R²⁵, and R²⁶ each independently represent a hydrogen atom, or an alkyl group having 1 or more and 6 or less carbon atoms, and b¹, b², and b³ each independently represent 0 or 1; in the formula (22), R³¹, R³², and R³³ each independently represent an alkyl group having 1 or more and 6 or less carbon atoms, R³⁴ represents an alkyl group having 1 or more and 6 or less carbon atoms, or a hydrogen atom, and d¹, d², and d³ each independently represent an integer of 0 or more and 5 or less; in the formula (23), R⁴¹, R⁴², R⁴³, R⁴⁴, R⁴⁵, and R⁴⁶ each independently represent an alkyl group having 1 or more and 6 or less carbon atoms, or a phenyl group, R⁴⁷ and R⁴⁸ each independently represent a hydrogen atom, an alkyl group having 1 or more and 6 or less carbon atoms, or a phenyl group, e¹, e², e³, and e⁴ each independently represent an integer of 0 or more and 5 or less, e⁵ and e⁶ each independently represent an integer of 0 or more and 4 or less, and e⁷ and e⁸ each independently represent 0 or 1; and in the formula (24), R⁵⁰ and R⁵¹ each independently represent an alkyl group having 1 or more and 6 or less carbon atoms, an alkoxy group having 1 or more and 6 or less carbon atoms, or a phenyl group, R³², R⁵³, R⁵⁴, R⁵⁵, R⁵⁶, R⁵⁷, and R⁵⁸ each independently represent a hydrogen atom, an alkyl group having 1 or more and 6 or less carbon atoms, an alkoxy group having 1 or more and 6 or less carbon atoms, or a phenyl group that may be substituted with an alkyl group having 1 or more and 6 or less carbon atoms, f¹ and f² each independently represent an integer of 0 or more and 2 or less, and f³ and f⁴ each independently represent an integer of 0 or more and 5 or less.

10. The electrophotographic apparatus according to claim 9, wherein the hole transporting material contains at least one compound selected from the group consisting of: a compound represented by the following formula (H-1); a compound represented by the following formula (H-2); a compound represented by the following formula (H-3); a compound represented by the following formula (H-4); a compound represented by the following formula (H-5); a compound represented by the following formula (H-6); a compound represented by the following formula (H-7); a compound represented by the following formula (H-8); a compound represented by the following formula (H-9); a compound represented by the following formula (H-10); and a compound represented by the following formula (H-11).

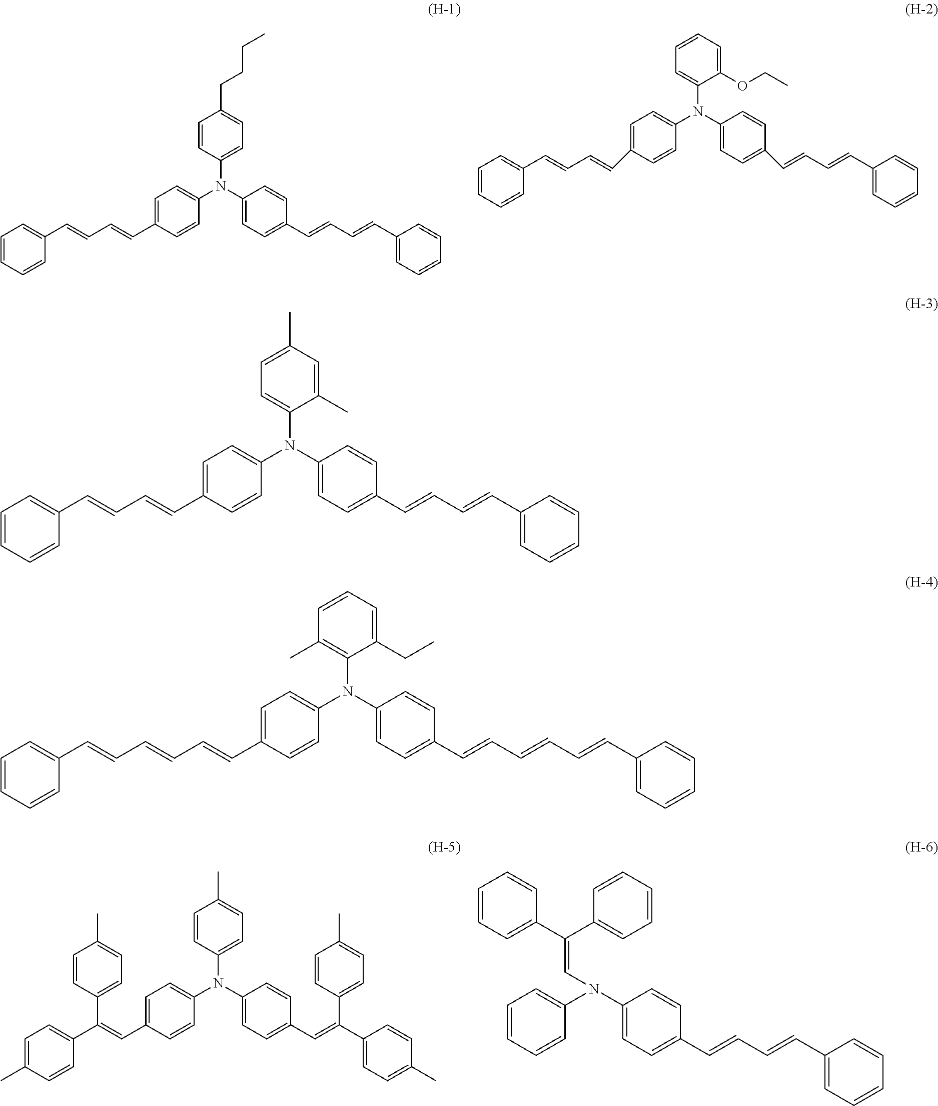

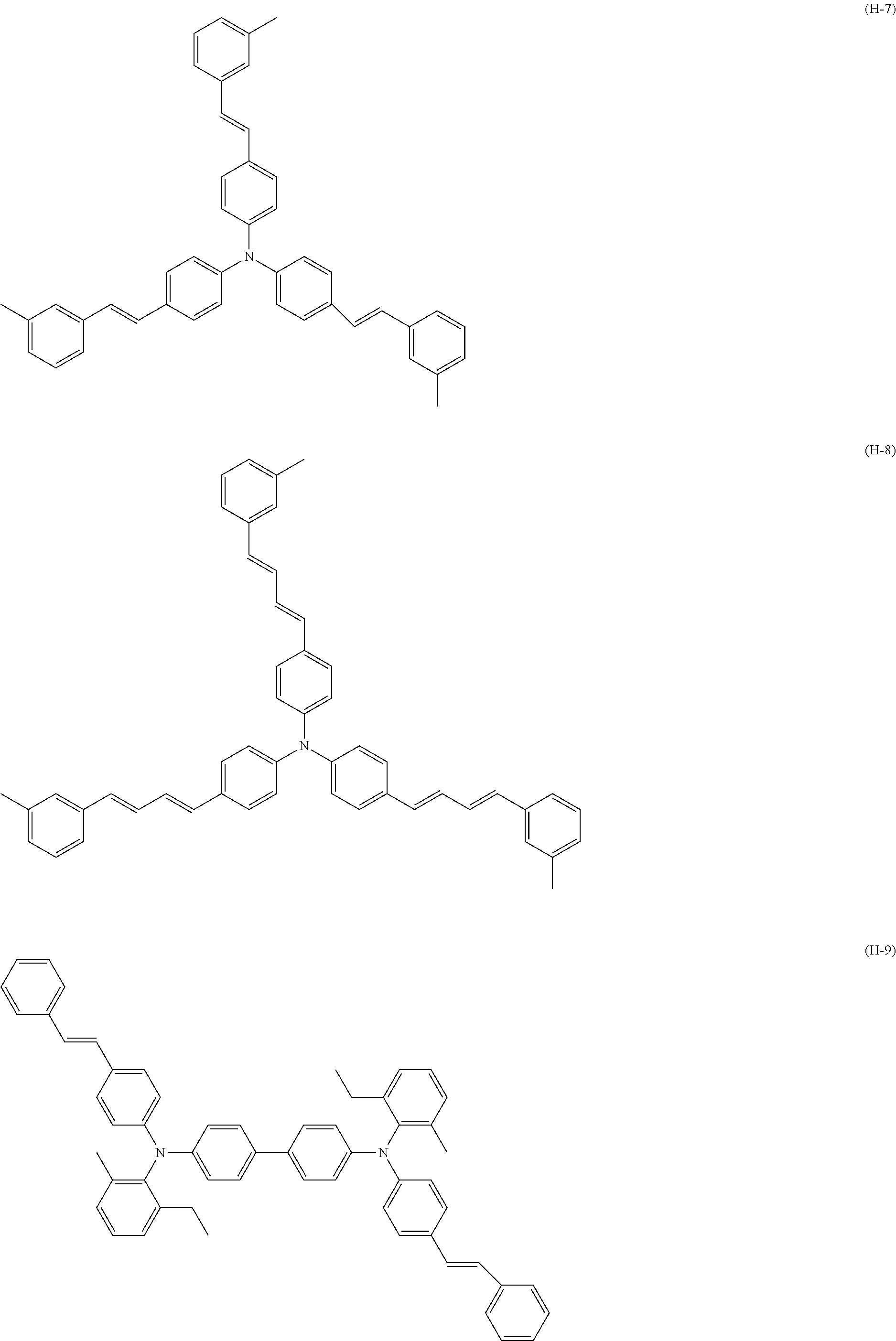 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1 ; CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1]

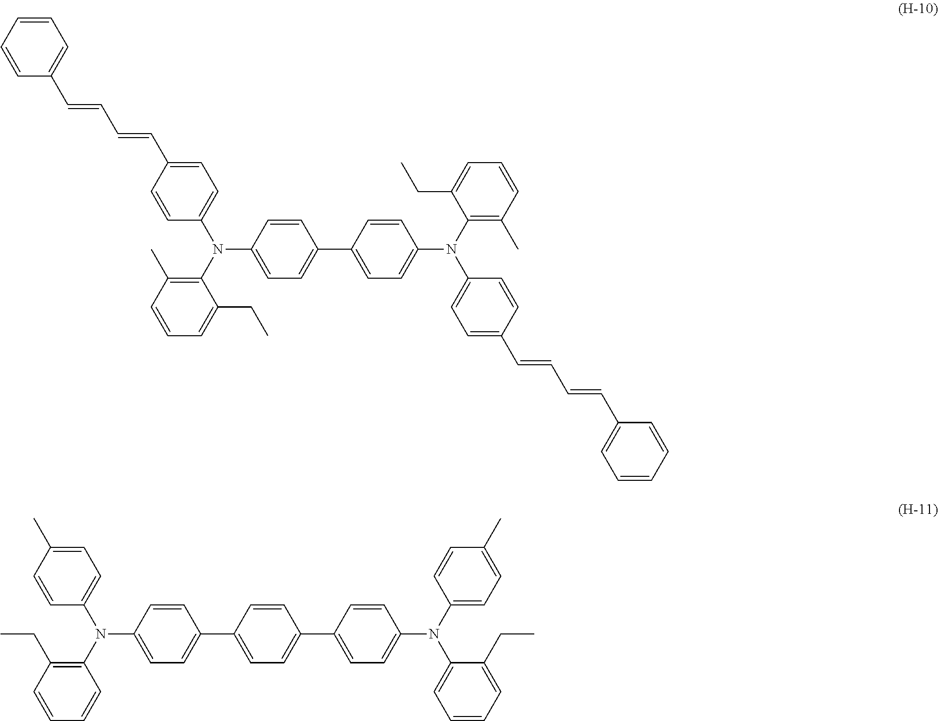 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

11. The electrophotographic apparatus according to claim 1, wherein the charge generating material contains titanyl phthalocyanine.

12. The electrophotographic apparatus according to claim 1, wherein the photosensitive layer contains a compound represented by the following formula (T-1).

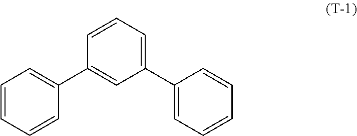 [SMILES: c1ccc(-c2cccc(-c3ccccc3)c2)cc1]

13. The electrophotographic apparatus according to claim 1, wherein the silica particle has an average particle diameter of 10 nm or more and 5 μm or less.

14. The electrophotographic apparatus according to claim 1,
wherein the coating layer contains a hydroxy group-containing ion liquid free of an ether group, and
wherein the ion liquid is at least one ion liquid selected from the group consisting of: an aliphatic amine-based ion liquid; a pyridinium-based ion liquid; and an imidazolium-based ion liquid.

15. The electrophotographic apparatus according to claim 14, wherein a content of the ion liquid in the coating layer is 0.1 part by mass or more and 10 parts by mass or less when a content of the second binder resin therein is set to 100 parts by mass.

16. The electrophotographic apparatus according to claim 1, wherein the coating layer contains at least one resin particle selected from the group consisting of: a crosslinked acrylic acid ester resin particle; and a crosslinked methacrylic acid ester resin particle.

17. The electrophotographic apparatus according to claim 16, wherein the at least one resin particle selected from the group consisting of: the crosslinked acrylic acid ester resin particle; and the crosslinked methacrylic acid ester resin particle has an average particle diameter of 1 μm or more and 15 μm or less.
